(19) United States
(12) Patent Application Publication
(10) Pub. No.: US 2024/0405612 A1
(43) Pub. Date: Dec. 5, 2024

(54) WIRELESS POWER TRANSMITTER HAVING MULTI-FREQUENCY OPERATION FOR REDUCED ELECTROMAGNETIC INTERFERENCE, AND RELATED METHODS AND APPARATUSES

(71) Applicant: Microchip Technology Incorporated, Chandler, AZ (US)

(72) Inventors: Santosh Bhandarkar, Chandler, AZ (US); Alex Dumais, Boise, ID (US)

(21) Appl. No.: 18/679,564

(22) Filed: May 31, 2024

Related U.S. Application Data
(60) Provisional application No. 63/505,662, filed on Jun. 1, 2023.

(51) Int. Cl. H02J 50/70; H02J 50/00; H02J 50/12

(52) U.S. Cl. CPC H02J 50/70; H02J 50/005; H02J 50/12

(57) ABSTRACT

A method comprises generating a wireless power transmission signal in one or more transmit coils of a wireless power transmitter and, in a multi-frequency operation of the wireless power transmitter, controlling an operating frequency of the wireless power transmission signal to repeatedly switch between a fundamental frequency and one of a lower frequency and an upper frequency in an alternating manner. The lower frequency is offset from the fundamental frequency by a first offset. The upper frequency is offset from the fundamental frequency by a second offset. The second offset is different from the first offset. The first offset associated with the lower frequency and the second offset associated with the upper frequency are to ensure a transmit power in the multi-frequency operation is substantially the same as a transmit power at the fundamental frequency.

### CROSS-REFERENCE TO RELATED APPLICATION

This application claims the benefit under 35 U.S.C. § 119 (e) of U.S. Provisional Patent Application No. 63/505,662, filed Jun. 1, 2023, and titled “Wireless Power Transmitter having Multi-Frequency Operation for Reduced Electromagnetic Interference,” the entire disclosure of which is hereby incorporated herein by reference.

### TECHNICAL FIELD

This disclosure relates generally to wireless power transmitters, and more particularly to wireless power transmitters having multi-frequency operation for reduced electromagnetic interference, without limitation.

### BACKGROUND

Wireless power transfer techniques are widely used to transfer power from one system to another in a wide range of applications. Qi is the most widely adopted standard for wireless power transfer using inductive charging and it has proliferated into nearly all consumer cell phone brands.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a block diagram of a wireless power system, according to one or more examples;

FIG. 2 is a schematic diagram of a wireless power system, according to one or more examples;

FIG. 3 is a schematic diagram of a transmitter of the wireless power system of FIG. 2, according to one or more examples;

FIG. 4 is a plot of waveforms of the transmitter of FIG. 2, according to one or more examples;

FIG. 5 is a plot of waveforms of the transmitter of FIG. 2, according to one or more examples;

FIG. 6 is a flowchart for describing a method of operating a wireless power transmitter for multi-frequency operation, according to one or more examples;

FIG. 7A is a flowchart for describing a method of configuring a wireless power transmitter for multi-frequency operation, according to one or more examples (e.g., for fixed fundamental frequency);

FIG. 7B is a flowchart for describing a method of configuring a wireless power transmitter for multi-frequency operation, according to one or more examples (e.g., for variable fundamental frequency);

FIG. 8 is a flowchart describing a method of configuring a wireless power transmitter for multi-frequency operation, according to one or more examples;

FIG. 9 is a flowchart of a method of a calibration process for an N coil system of a wireless power transmitter, according to one or more examples;

FIG. 10 is a plot of root mean square (RMS) coil current versus operating frequency for example calibration data points from a calibration process of a wireless power transmitter, according to one or more examples;

FIG. 11 is a plot of operating frequency versus RMS coil current for the example calibration data points from the calibration process of the wireless power transmitter, according to one or more examples;

FIG. 12 is a graph of a continuous curve of FIG. 10 based on the example calibration data points for describing an example selection of a frequency pattern for multi-frequency operation, according to one or more examples;

FIG. 13 is a plot of the selected data points of FIG. 12 with indication of specific frequency and RMS coil current values associated with each data point, according to one or more examples;

FIG. 14 is a plot of example data points of operating frequency versus time for a wireless power transmission signal during multi-frequency operation, according to one or more examples;

FIG. 15 is a graph of a coil voltage signal at an input of an analog-to-digital converter (ADC) during multi-frequency operation, according to one or more examples;

FIG. 16 is a graph of receiver voltage spectrum versus frequency of a wireless power transmitter, with and without frequency dithering enabled, according to one or more examples; and

FIG. 17 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples in which the present disclosure may be practiced. These examples are described in sufficient detail to enable a person of ordinary skill in the art to practice the present disclosure. However, other examples enabled herein may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an examples or this disclosure to the specified components, steps, acts, features, functions, or the like.

It will be readily understood that the components of the examples as generally described herein and illustrated in the drawings could be arranged and designed in a wide variety of different configurations. Thus, the following description of various examples is not intended to limit the scope of the present disclosure but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a digital signal processor (DSP), an Integrated Circuit (IC), an Application Specific Integrated Circuit (ASIC), a Field-Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Various examples disclosed herein may be implemented by wireless power transmitters. Various examples disclosed herein may, however, also be implemented in other devices associated with multi-frequency operation.

A Qi wireless system includes a wireless power transmitter (“transmitter”) and a wireless power receiver (“receiver”). The transmitter includes at least one transmitter coil with which a receiver coil is coupled (e.g., inductively coupled) in the system. In a multi-coil transmitter design, there are multiple transmitter coils overlapping each other so that the receiver coil may be placed on any of the transmitter coils. This provides spatial freedom for receiver placement and an approximate placement on the transmitter ensures power transfer. This contrasts with a single coil transmitter where the receiver coil should be properly aligned with the transmitter coil for power transfer.

In general, the transmitter controls the power transferred to the receiver based on the feedback received from the receiver and coil current amplitude. The receiver communicates the difference in power level by sending a packet including an eight (8)-bit signed number. The transmitter uses the coil current amplitude measured before the packet's arrival as a reference to either increase or decrease the power level to the receiver. The transmitter may use fixed frequency and variable input voltage, variable frequency, variable phase, variable duty cycle, or a combination or sub-combination thereof, without limitation, to control the power transmitted.

The communication between the receiver and the transmitter is done in-band by altering the electrical conditions at the receiver. The change in state can be implemented using a switching resistance or a switching capacitance at the receiver. The change in the capacitance or resistance at the receiver causes a change in the coil voltage or coil current at the transmitter. At the transmitter, the feedback appears as a stream of bits riding over the fundamental frequency (e.g., typically from 110 kilohertz (kHz) to 148 kHz) used for power transfer. The rate of change is typically between 1 kHz to 2 kHz to transmit the bit stream from the receiver to the transmitter. The transmitter typically observes an amplitude change on the order of few millivolts/milliamps to hundreds of millivolts/milliamps depending on the alignment of the receiver coil with the transmitter coil, input voltage, and load conditions, without limitation.

One of the concerns of the transmitter relates to undesired emitted radiation during wireless power transfer. The transmitter coil emits radiation at a certain frequency in the form of magnetic flux. In ideal conditions, if all the emitted flux links to the receiver, there is no leakage of radiation. In actual conditions, however, flux leakage leads to undesired emitted radiation. Undesired emitted radiation can be prevented to some extent by a proper selection of components, a strong adherence to layout guidelines, and a suitable containing of the transmitter within a metal housing. If such prevention mechanisms are overdone, however, unnecessary power losses and heating of metal due to flux linkage may result.

Wireless power transmitters are typically tested against regulatory requirements associated with Electromagnetic Interference (EMI)/Electromagnetic Compatibility (EMC). For example, the Wireless Power Consortium has recommended using the Comité International Spécial des Perturbations Radioélectriques (CISPR) 25 standard for transmitters in the automotive industry. The CISPR 25 standard has stringent requirements for frequency emissions beyond 150 kHz up to 30 Megahertz (MHZ).

In present-day transmitters, limiting the frequency for wireless power transfer to 148 kHz avoids the stringent requirements for frequency emissions above 150 kHz. However, future specifications may support wireless power transfer at frequencies above 150 kHz. For example, there are recent proposals to support frequencies for wireless power transfer in the range of 360 kHz. Thus, in the near future, it may be increasingly difficult for transmitters (e.g., especially transmitters operating at frequencies above 150 kHz) to be compliant with emission standards unless innovative solutions are realized.

According to one or more examples of the disclosure, a wireless power transmitter is to perform wireless power transfer at multiple frequencies rather than a single frequency under equilibrium condition. Such multi-frequency operation spreads the energy content of emitted radiation across multiple frequencies and their harmonics rather than concentrating the energy at a single frequency. Spreading the energy content of emitted radiation across multiple frequencies reduces undesired emitted radiation at a particular frequency. In one or more examples, the undesired emitted radiation from the transmitter may be reduced to be compliant with emission standards.

In one or more examples, the transmitter has a multi-frequency operation utilizing a frequency pattern that includes a fundamental frequency, a lower adjacent frequency (“lower frequency”) relative to the fundamental frequency, and an upper adjacent frequency (“upper frequency”) relative to the fundamental frequency. In at least some instances, the multi-frequency operation of the transmitter may be referred to herein as “frequency dithering.”

In a specific, non-limiting example, an operating frequency of a wireless power transmission signal may be controlled to repeatedly switch between the fundamental frequency and one of the lower frequency and the upper frequency in an alternating manner. For example, the operating frequency may be switched from the fundamental frequency to the lower frequency and then back to the fundamental frequency, and from the fundamental frequency to the upper frequency and then back to the fundamental frequency, and again from the fundamental frequency to the lower frequency and then back to the fundamental frequency, and so on, in a repeated alternating manner. In one or more examples, the switching between frequencies in the alternating manner is performed at a predetermined rate. In a specific, non-limiting example, the repeated switching between the frequencies in the alternating manner is performed at a rate of greater than or equal to 20 kilohertz (kHz).

Note that, unlike conventional power supplies, a wireless power transmitter utilizes an inductor-capacitor (LC) resonant circuitry whose gain is not linear with frequency. That is, the LC resonant circuitry of a wireless power transmitter exhibits a non-linear relationship between operating frequency and transmit power. Without innovative techniques, a wireless power transmitter having multi-frequency operation will lead to issues associated with power balance, demodulation, and frequency-shift keying (FSK) communication, which are key factors for efficient operation of the transmitter.

Given the non-linear relationship between operating frequency and transmit power, in one or more examples, the lower frequency and the upper frequency are selected or determined to be offset asymmetrically relative to the fundamental frequency to ensure the transmit power in the multi-frequency operation is substantially the same as the transmit power at the fundamental frequency. For example, the lower frequency may be offset from the fundamental frequency by a first offset, the upper frequency may be offset from the fundamental frequency by a second offset, and the second offset may be different from the first offset. Here, the first offset and the second offset are selected or determined to ensure a transmit power in the multi-frequency operation is substantially the same as a transmit power at the fundamental frequency.

As transmit power of the transmitter is proportional to the square of a root mean square (RMS) coil current through one or more transmit coils of the transmitter, the first offset and the second offset may be selected to ensure a square of an RMS coil current through the one or more transmit coils in the multi-frequency operation is substantially the same as a square of an RMS coil current through the one or more transmit coils at the fundamental frequency. Accordingly, as an approximation of the above, the first offset and the second offset may be selected to ensure an RMS coil current through one or more transmit coils in the multi-frequency operation is substantially the same as an RMS coil current through the one or more transmit coils at the fundamental frequency.

In one or more examples, the fundamental frequency is a predetermined fixed frequency which remains (relatively) unchanged over transmitter operation. Here, for multi-frequency operation of the transmitter, the lower frequency and the upper frequency may be selected or determined relative to the fundamental frequency during a calibration procedure of the transmitter (e.g. prior to normal operation of the transmitter).

In one or more other examples, the fundamental frequency is a variable frequency which is selected or determined during normal operation of the transmitter (e.g., based on feedback from the receiver). For multi-frequency operation of the transmitter, the lower frequency and the upper frequency may be selected or determined relative to the fundamental frequency during normal operation of the transmitter.

In one or more examples, the selection or determination of the lower frequency and the upper frequency may be at least partially based on information stored in the calibration procedure of the transmitter. In one or more examples, in the calibration procedure, the transmitter is to, at respective frequency points of multiple frequency points over a frequency range, generate a wireless power transmission signal at a respective frequency point, sample a coil current through the one or more transmit coils produced from the wireless power transmission signal at the respective frequency point, and store in memory a respective sampled coil current value in association with the respective frequency point.

Subsequently, the transmitter may determine a non-linear expression of operating frequency versus RMS coil current or power at least partially based on sampled coil current values stored in association with the respective frequency points (e.g., based on a least-squares method). The transmitter may store, in memory, parameters that represent, at least in part, the non-linear expression of operating frequency versus RMS coil current or power of the transmitter. Even further, the transmitter may determine a non-linear expression of RMS coil current or power versus operating frequency at least partially based on sampled coil current values stored in association with the respective frequency points (e.g., based on a least-squares method). Again, the transmitter may store, in memory, parameters that represent, at least in part, the non-linear expression of RMS coil current or power versus operating frequency of the transmitter.

In one or more examples, the lower frequency may be determined relative to the fundamental frequency, for example, at least partially based on a predetermined minimum frequency spread at or relative to the fundamental frequency. Subsequently, in one or more examples, the upper frequency may be determined relative to the fundamental frequency and the lower frequency, for example, at least partially based on an output result of the non-linear expression of operating frequency versus RMS coil current or power, using a determined value of the RMS coil current or power at the upper frequency as an input.

In one or more specific examples, the determined value of the RMS coil current or power at the upper frequency may be at least partially based on a coil current difference between the second RMS coil current or power at the lower frequency and the first RMS coil current or power at the fundamental frequency. More specifically, the determined value of the RMS coil current or power at the upper frequency may be determined to be substantially equal or proportional to a difference between the first RMS coil current or power and the coil current difference between the second RMS coil current or power and the first RMS coil current or power. Here, in one or more examples, the first RMS coil current or power may be determined at least partially based on an output result of a non-linear expression of RMS coil current or power versus operating frequency using the fundamental frequency as an input. In addition, the second RMS coil current or power may be determined at least partially based on an output result of the non-linear expression of RMS coil current or power versus operating frequency using the lower frequency as an input.

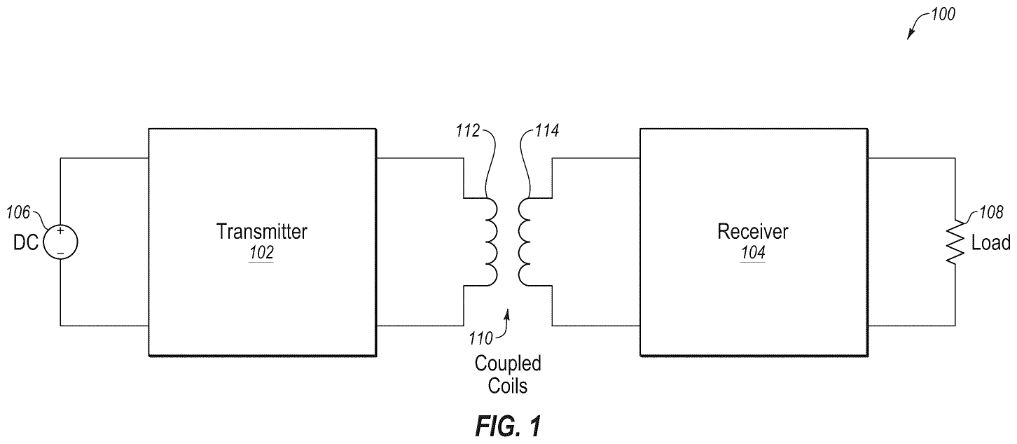

FIG. 1 is a block diagram of a wireless power system 100, according to one or more examples. Wireless power system 100 includes a transmitter 102 and a receiver 104. Transmitter 102 is powered by a DC voltage source 106, and receiver 104 is connected to a load 108. The power is transferred from transmitter 102 to receiver 104 through a set of coupled coils 110 (i.e., from a transmitter coil 112 to a receiver coil 114). Transmitter 102 controls the power transferred by controlling the input voltage, frequency, phase, and/or duty cycle of the signal applied to transmitter coil 112. Power is transferred by magnetic flux linkage; there is no physical connection between transmitter 102 and receiver 104. Typically, the power transmission is most efficient when transmitter and receiver coils 112 and 114 are placed one over the other and are aligned.

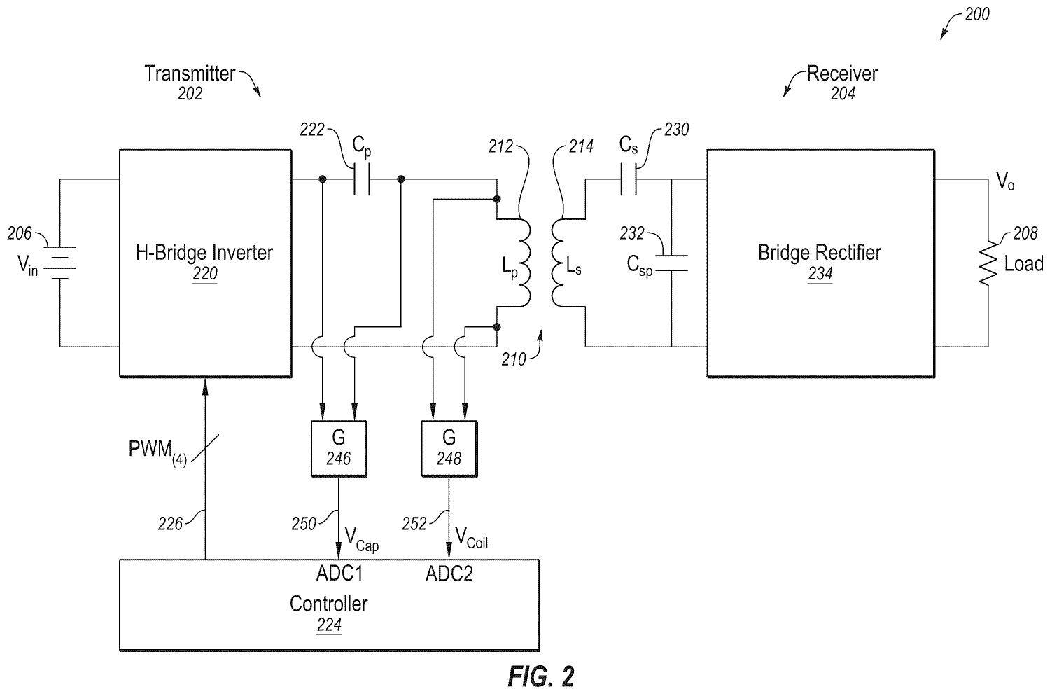

FIG. 2 is a schematic diagram of a wireless power system 200, according to one or more examples. Like the wireless power system of FIG. 1, wireless power system 200 of FIG. 2 includes a transmitter 202 and a receiver 204. In one or more examples, transmitter 202 is included as part of a first device (or unit), and receiver 204 is included as part of a second device (or unit), where the second device is separate and apart from the first device (e.g., the second device may be movable and relocatable independent of the first device).

In general, power is transferred from transmitter 202 to receiver 204 through a set of coupled coils 210 (i.e., from a transmitter coil 212 (Lp) of transmitter 202 to a receiver coil 214 (Ls) of receiver 204). Transmitter 202 includes an H-bridge inverter 220 and a capacitor 222 (Cₚ) electrically connected in series with transmitter coil 212. Capacitor 222 may be referred to as a “transmitter tank capacitor,” and more generally as a “series capacitor.” A resonant tank circuit formed by capacitor 222 (Cₚ) and transmitter coil 212 (Lp) is connected across the output of H-bridge inverter 220. Transmitter 202 is powered by a DC voltage source 206. The input to H-bridge inverter 220 comes directly from the source or from the output of a four-switch buck boost converter (FSBBC), which controls the input voltage to H-bridge inverter 220. A controller 224 may drive H-bridge inverter 220 with pulse-width modulated (PWM) signals 226 or pulses. In one or more examples, controller 224 may be a microcontroller, such as a dsPIC microcontroller, digital signal controller (DCS), digital signal processor, and so on, without limitation. In one or more examples, the PWM signals 226 may provide either a fixed fundamental frequency or a variable fundamental frequency depending on the particular topology of transmitter 202.

Receiver 204 includes a capacitor 230 (Cs), a capacitor 232 (Csp), and a bridge rectifier 234 (e.g., a diode bridge) connected to a load 208. Capacitor 230 is electrically connected in series with receiver coil 214, and capacitor 232 is electrically connected in parallel with the series-connected capacitor 230 and receiver coil 214. Capacitor 230 (Cs) may be referred to as a “receiver tank capacitor,” and more generally as a “series capacitor.” A resonant tank circuit is formed by receiver coil 214 and capacitors 230 and 232. The output of the resonant tank circuit is passed through bridge rectifier 234, which rectifies the voltage. The output of bridge rectifier 234 is passed through either a buck converter or a low-dropout (LDO) regulator, which provides a fixed voltage (Vo) at load 208.

In one or more examples, controller 224 is to detect coil current through transmitter coil 212. In one or more examples, controller 224 is to detect coil current through transmitter coil 212 with use of a current sensor (not shown in FIG. 2). In one or more other examples, controller 224 is to detect coil current through transmitter coil 212 indirectly based on (e.g., consecutively) sampled capacitor voltages across capacitor 222 (Cₚ) (e.g., without use of a current sensor). The detection of capacitor voltage potentials across the series capacitor may be used to derive a current flowing through the capacitor by differentiating the capacitor voltage potential (e.g., based on a rate of change of the sampled capacitor voltages). As capacitor 222 is coupled in series with transmitter coil 212, the current through capacitor 222 is substantially the same as the coil current. For this purpose, controller 224 has an input 250 to a first analog-to-digital converter (ADC) for sampling capacitor voltages across capacitor 222 (Cₚ), for example, via a gain circuit 246 (e.g., a differential amplifier).

In one or more other examples, controller 224 is to compute a coil power of transmitter 202 based on the determined coil current. In one or more examples, the coil power may be computed based on the determined coil current and sampled coil voltages across transmitter coil 212 (Lₚ). For this purpose, controller 224 has an input 252 to a second ADC for sampling coil voltages across transmitter coil 212 (Lₚ) via a gain circuit 248 (e.g., a differential amplifier).

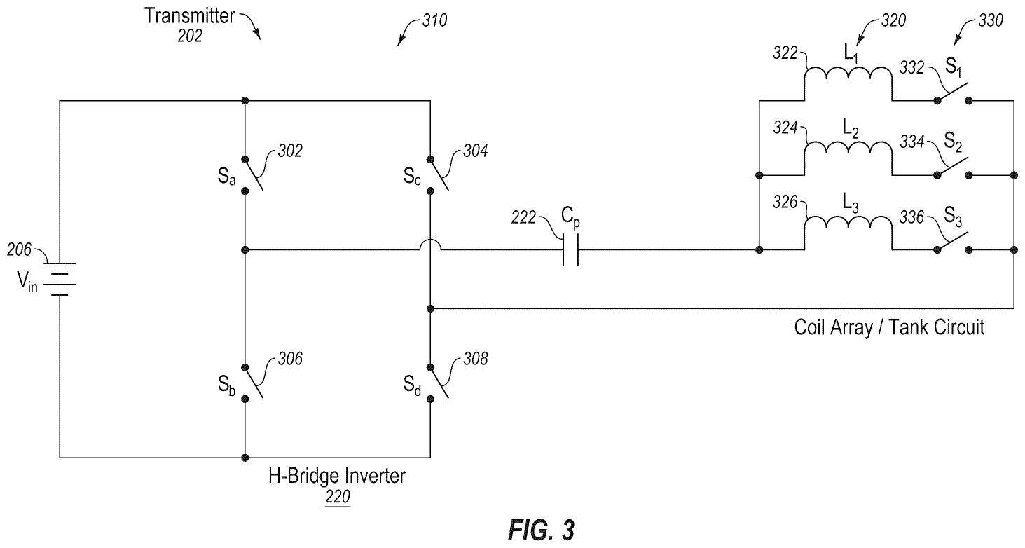

FIG. 3 is a schematic diagram of transmitter 202 of the wireless power system of FIG. 2, according to one or more examples. In FIG. 3, transmitter 202 is shown to be a multi-coil transmitter including a coil array 320 of multiple coils. Coil array 320 of the multiple coils include a coil 322 (designated “L₁”), a coil 324 (designated “L₂”), and a coil 326 (designated “L₃”). Respective ones of coils 322, 324, and 326 are coupled in series with respective ones of multiple switches 330 including a switch 332 (designated “S₁”), a switch 334 (designated “S₂”), and a switch 336 (designated “S₃”).

H-bridge inverter 220 is coupled to coil array 320 and includes multiple switches 310. Multiple switches 310 of H-bridge inverter 220 include a switch 302 (designated “Sₐ”), a switch 304 (designated “S_{b}”), a switch 306 (designated “S_{c}”), and a switch 308 (designated “S_{d}”). In one or more examples, switches 302, 304, 306, and 308 are metal-oxide semiconductor field-effect transistors (MOSFETs) driven by MOSFET drivers.

For coupling H-bridge inverter 220 to coil array 320, capacitor 222 has a first end coupled between switches 302 and 306 of H-bridge inverter 220 and a second end coupled to first ends of (the switchably connected) coils 322, 324, and 326. Second ends of (the switchably connected) coils 322, 324, and 326 are coupled between switches 304 and 308 of H-bridge inverter 220. A resonant tank circuit is formed by capacitor 222 (Cₚ) and a selected one of coils 322, 324, and 326 connected across an output of H-bridge inverter 220.

The controller (e.g., controller 224 of FIG. 2) is to control operation of H-bridge inverter 220. In example operation, the controller controls switches 302 and 308 to turn on in a positive half cycle, and controls switches 304 and 306 to turn on in the other half cycle. In a specific, non-limiting example, the controller includes PWM signal outputs operably coupled to inputs of the MOSFET drivers to drive the MOSFETs (i.e., multiple switches 310). In one or more examples, the fundamental frequency of operation may be fixed (e.g., at 125 kHz) for a selected topology. In one or more other examples, the fundamental frequency of operation is variable.

H-bridge inverter 220 applies an alternating current (AC) voltage across the resonant tank circuit formed by capacitor 222 and the selected one of coils 322, 324, and 326. When one of switches 332, 334, and 336 is closed, it places a respective one of coils 322, 324, and 326 in the resonant tank circuit (only one of coils 322, 324, and 326 is connected to H-bridge inverter 220 at a time). In one or more examples, switches 332, 334, and 336 may be made of back-to-back MOSFETs for conducting bidirectional AC current in the resonant tank circuit.

With reference back to FIG. 2, the frequency or the duty cycle or the phase of H-bridge inverter 220 may be varied to control the power transferred. The tank input voltage may be controlled to control the power transferred via an additional, optional, power stage (not depicted in the figures) between input voltage source and the inverter. This results in a fixed frequency operation. The frequency for the MPA9 or MPA13 topology type of transmitter 202 with voltage control has a fixed frequency of 120 kHz. In variable frequency topologies (e.g., MPA22), the fundamental frequency may vary from 110 kHz to 148 kHz. The input voltage to H-bridge inverter 220 is generally constant or varying depending on the type of receiver 204. For MPA22, the input voltage is fed from the output of a Universal Serial Bus (USB) power delivery (USBPD) device. With 5 Watt (W) Baseline Power Profile (BPP) receivers, the USBPD voltage is set to 5 V, while for 15 W Extended Power Profile (EPP) receivers, the USBPD voltage is set to 9 V. When the frequency hits the upper limit of 148 kHz, the control mode may change from frequency control to duty cycle control. The duty cycle may be varied at the fixed frequency and maintained between 10% and 50%.

According to one or more examples of the disclosure, transmitter 202 has a multi-frequency operation to be described in more detail in relation to the figures. The multi-frequency operation was tested in relation to two different topologies/boards, namely, the MPA13 topology and the MPA22 topology. The MPA13 topology primarily uses voltage mode control at a fixed frequency (e.g., 120 kHz), while the MPA22 topology uses frequency control from 110 kHz to 148 kHz. For fixed frequency topologies (e.g., MPA13), multi-frequency operation is relatively straightforward, using a frequency pattern which includes the fundamental frequency, a lower (adjacent) frequency, and an upper (adjacent) frequency determined and preset according to prototype values. For variable frequency topologies (e.g., MPA22), the fundamental frequency is a function of several variables, such as receiver type, receiver coupling, receiver load, and so on. The fundamental frequency may be determined and set according to normal operation. Once the power transfer stage is reached, frequency dithering is enabled which changes the single fundamental frequency into a pattern of frequencies which include the fundamental frequency and a determined lower frequency and a determined upper frequency. In one or more examples, the frequency pattern in multi-frequency operation is designed to maintain the same power level as that of the fundamental frequency alone. Put another way, the multi-frequency operation at the selected frequencies ensures little or no change in power level.

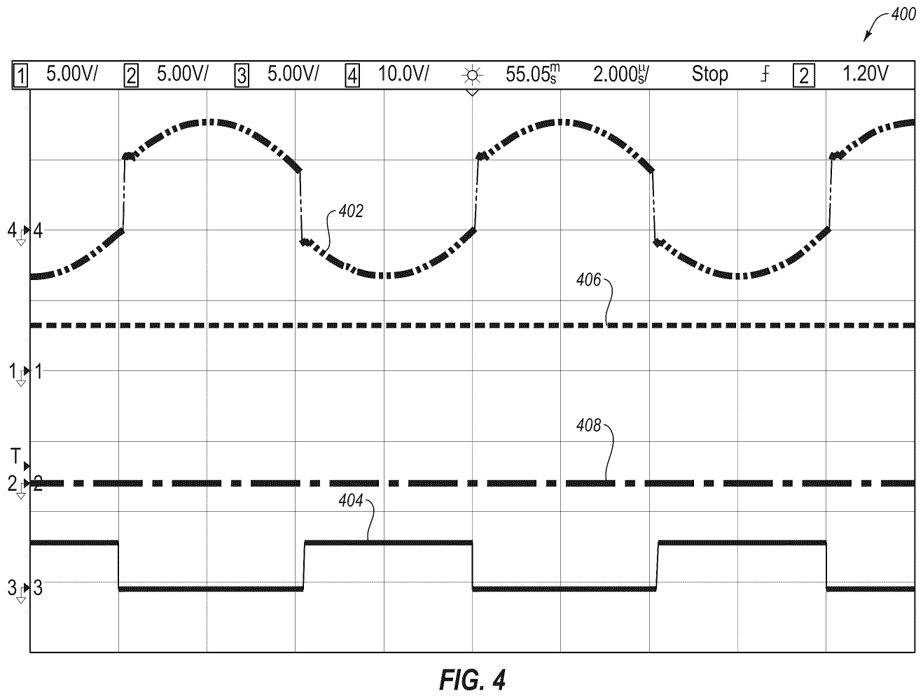

FIG. 4 is a plot of waveforms 400 of transmitter 202 of FIG. 2, according to one or more examples. Waveforms 400 include a coil voltage potential signal 402 of a coil voltage potential, a PWM signal 404, a demodulated signal 406, and a packet good signal 408 to indicate proper decoding of the signal. Coil voltage potential signal 402 is rectified with a diode and stepped down (e.g., to 3.3 V) using a resistor divider. Accordingly, if needed, a positive portion of the coil voltage potential may be applied to an ADC at the input of the controller (e.g., input 252 of the second ADC of FIG. 2, and controller 224 of FIG. 2).

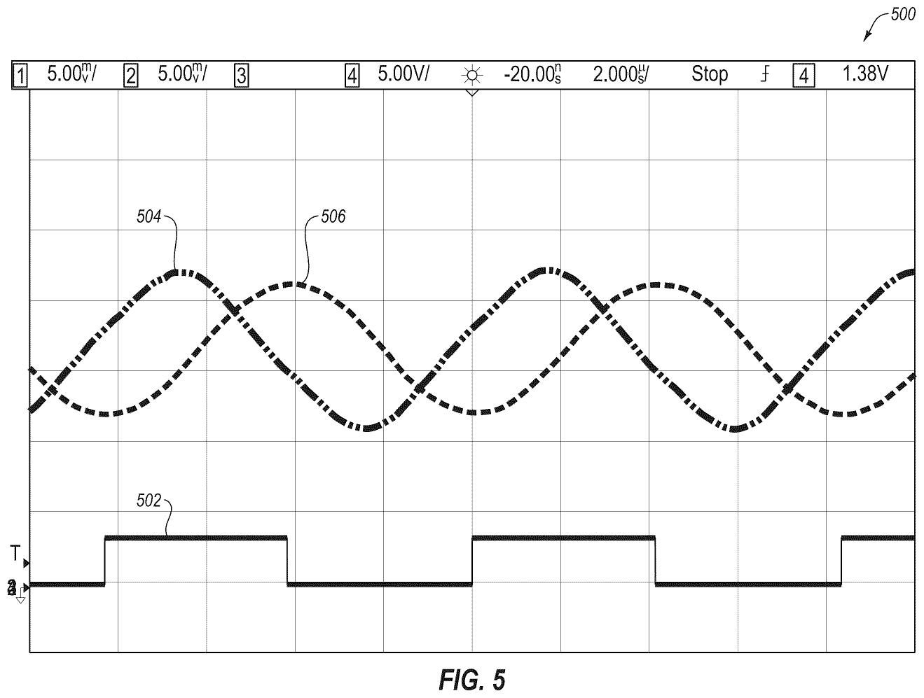

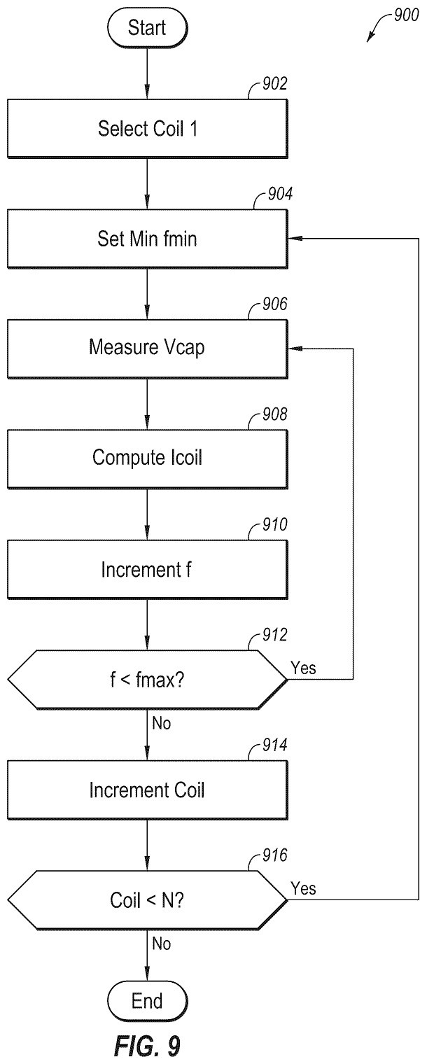

FIG. 5 is a plot of waveforms 500 of transmitter 202 of FIG. 2, according to one or more examples. In particular, waveforms 500 may be waveforms of transmitter 202 of FIG. 2. Waveforms 500 include a PWM signal 502, a coil voltage potential signal 504, and a capacitor voltage potential signal 506. In one or more examples, capacitor voltage potential signal 506 may be used to derive an RMS coil current through the one or more transmit coils. In one or more examples, capacitor voltage potential signal 506 may be used to derive the square of the RMS coil current through the one or more transmit coils, which is proportional to transmit power. In one or more examples, capacitor voltage potential signal 506 and coil voltage potential signal 504 may be used to derive the transmit power of transmitter 202. Capacitor voltage potential signal 506 may be applied to an ADC at an input of the controller (e.g., input 250 of the first ADC of FIG. 2, and controller 224 of FIG. 2), and coil voltage potential signal 504 may be applied to an ADC at an input of the controller (e.g., input 252 of the second ADC of FIG. 2, and controller 224 of FIG. 2). See, for example, the further description of an example calibration process in relation to FIG. 9.

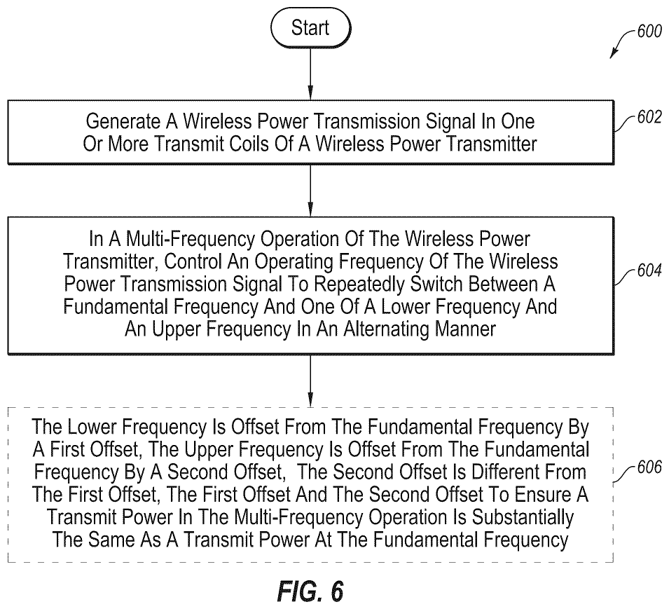

FIG. 6 is a flowchart for describing a method 600 of operating a wireless power transmitter for multi-frequency operation, according to one or more examples. In one or more examples, the wireless power transmitter includes an L-C resonant circuitry exhibiting a non-linear relationship between the operating frequency and the transmit power (e.g., and/or the square of RMS coil current, and/or the RMS coil current).

At an act 602, a wireless power transmission signal is generated in one or more transmit coils of the wireless power transmitter. At an act 604, in a multi-frequency operation of the wireless power transmitter, an operating frequency of the wireless power transmission signal is controlled to repeatedly switch between a fundamental frequency and one of a lower frequency and an upper frequency in an alternating manner. In one or more examples, in the act 604, the operating frequency of the wireless power transmission signal is controlled to repeatedly switch in the alternating manner at a predetermined rate (e.g., a predetermined rate of greater than or equal to 20 kHz).

At a characterization box 606, the lower frequency is offset from the fundamental frequency by a first offset, the upper frequency is offset from the fundamental frequency by a second offset, and the second offset is different from the first offset. The first offset associated with the lower frequency and the second offset associated with the upper frequency are to ensure a transmit power in the multi-frequency operation is substantially the same as a transmit power at the fundamental frequency.

In one or more examples, the first offset associated with the lower frequency and the second offset associated with the upper frequency are to ensure that a square of an RMS coil current through the one or more transmit coils in the multi-frequency operation (e.g., as an approximation of the transmit power in the multi-frequency operation) is substantially the same as a square of the RMS coil current through the one or more transmit coils at the fundamental frequency (e.g., as an approximation of the transmit power at the fundamental frequency). In one or more other examples, the first offset associated with the lower frequency and the second offset associated with the upper frequency are to ensure that an RMS coil current through the one or more transmit coils in the multi-frequency operation (e.g., as an approximation of the transmit power in the multi-frequency operation) is substantially the same as an RMS coil current through the one or more transmit coils at the fundamental frequency (e.g., as an approximation of the transmit power at the fundamental frequency).

In one or more examples, at least one of the lower frequency or the upper frequency is determined at least partially based on a non-linear expression of operating frequency versus RMS coil current or power, a non-linear expression of RMS coil current or power versus operating frequency, or both. In one or more examples, multiple parameters that represent, at least in part, the non-linear expression(s) are stored in memory of the wireless power transmitter, and subsequently used to determine the at least one of the lower frequency or the upper frequency.

In one or more examples, the determining of the upper frequency is at least partially based on an output result of the non-linear expression of operating frequency versus RMS coil current or power using a determined value of the RMS coil current or power at the upper frequency as an input. In one or more examples, the determined value is at least partially based on a coil current difference between the RMS coil current or power at the lower frequency and an RMS coil current or power at the fundamental frequency. In one or more specific examples, the determined value of the RMS coil current or power at the upper frequency is substantially equal or proportional to a difference between the RMS coil current or power at the fundamental frequency and the coil current difference between the RMS coil current or power at the lower frequency and the RMS coil current or power at the fundamental frequency.

In one or more examples, the RMS coil current or power at the fundamental frequency is determined at least partially based on an output result of a non-linear expression of RMS coil current or power versus operating frequency using the fundamental frequency as an input. In one or more examples, the RMS coil current or power at the lower frequency is determined at least partially based on an output result of the non-linear expression of RMS coil current or power versus operating frequency using the lower frequency as an input.

In one or more examples, the fundamental frequency is determined to be a predetermined fixed frequency of the wireless power transmitter. In one or more other examples, the fundamental frequency is variable over a predetermined range, and is determined at least partially based on an indication in a communication received from a wireless power receiver. In one or more examples, the lower frequency is determined relative the fundamental frequency at least partially based on a predetermined minimum frequency spread at or relative to the fundamental frequency. In one or more specific examples, the lower frequency may be determined at least partially based on the predetermined minimum frequency spread using at least some discretion (e.g., the lower frequency may be offset from the fundamental frequency by a value that is equal to or greater than half of the predetermined minimum frequency spread, for example, within a certain percentage).

Although method 600 of FIG. 6 describes a multi-frequency operation including a fundamental frequency, a lower frequency, and an upper frequency, more generally the multi-frequency operation may utilize a frequency pattern including a fundamental frequency, one or more lower frequencies (e.g., multiple lower frequencies) relative to the fundamental frequency, and one or more upper frequencies (e.g., multiple upper frequencies) relative to the fundamental frequency, according to one or more examples. In addition, although method 600 of FIG. 6 describes the determination of the lower frequency before the determination of the upper frequency, the method may alternatively provide for the determination of the upper frequency before the determination of the lower frequency (e.g., in a reverse fashion utilizing the same or similar non-linear expressions and calculations). Further, in one or more examples, respective ones of the non-linear expressions or relationships described herein may be represented or approximated by a piecewise linear function, and therefore the phrase “non-linear expression” is intended to encompass non-linear expressions, piecewise linear expressions or functions of the non-linear expressions, other linear approximations of the non-linear expressions, and equivalents thereof.

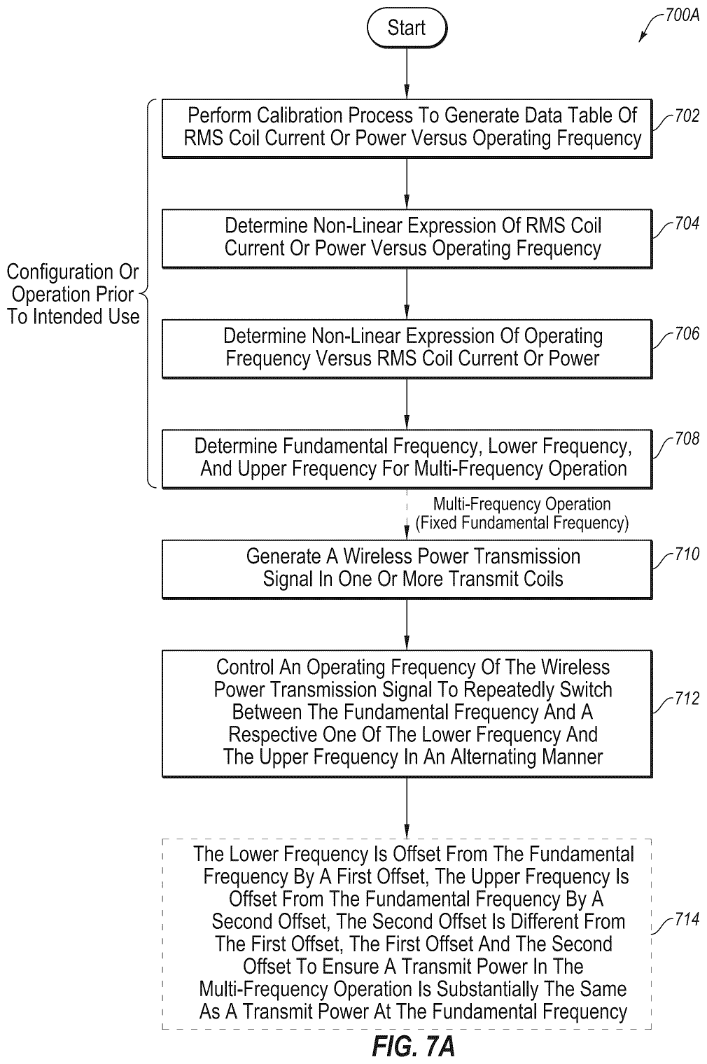

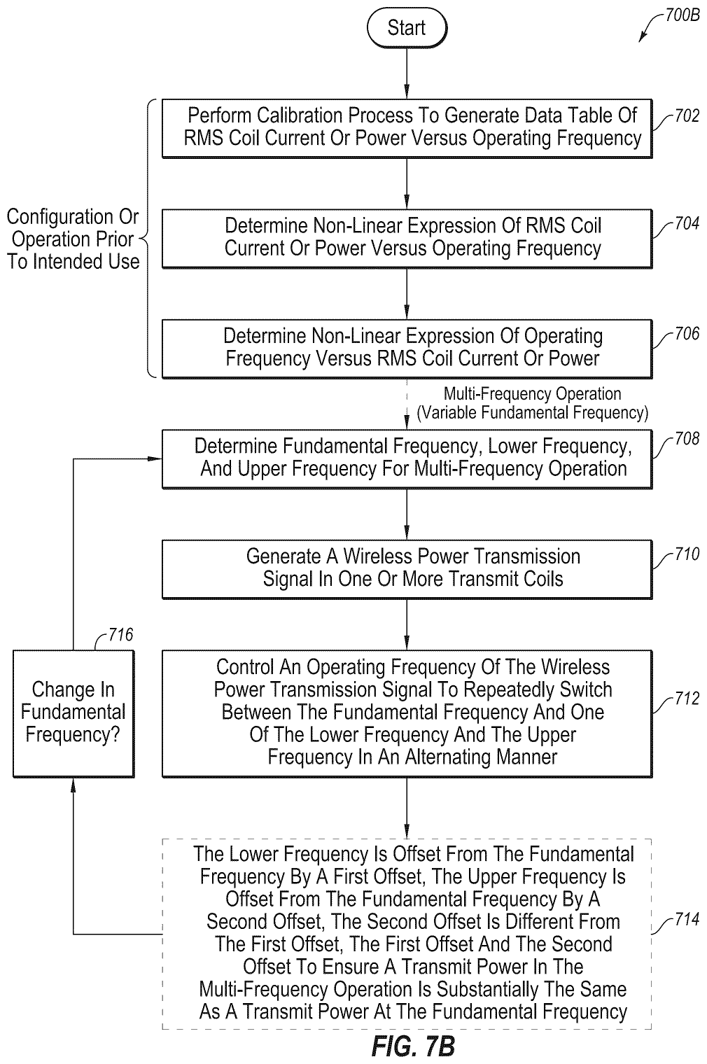

FIG. 7A is a flowchart for describing a method 700A of configuring a wireless power transmitter for multi-frequency operation, according to one or more examples. Method 700A is related to the configuration of a wireless power transmitter having a predetermined (e.g., fixed) fundamental frequency. In one or more examples, the wireless power transmitter includes an L-C resonant circuitry exhibiting a non-linear relationship between operating frequency and transmit power (e.g., and/or the square of RMS coil current, and/or the RMS coil current).

At an act 702, a calibration process is performed to generate a data table of RMS coil current or power versus operating frequency. The calibration process may involve the following acts. At respective frequency points of multiple frequency points over a frequency range, the calibration process comprises generating a wireless power transmission signal at a respective frequency point, sampling a coil current through the one or more transmit coils produced from the wireless power transmission signal at the respective frequency point, and storing in memory a respective sampled coil current value in association with the respective frequency point. In one or more examples, the square of the RMS coil current is stored and/or used to better approximate power. In one or more examples, the coil current may be sampled with use of a current sensor, or alternatively, sampled based on (consecutively) sampled capacitor voltages across a series capacitor (e.g., where the coil current is calculated based on a rate of change between previous and current capacitor voltage samples). In one or more examples, the calibration process in act 702 may be performed based on the method of FIG. 9 described later below.

At an act 704, a non-linear expression of RMS coil current or power versus frequency is determined at least partially based on sampled coil current values (or squares thereof) stored in association with the respective frequency points in act 602. The non-linear expression may be stored in memory for subsequent use. For example, multiple parameters that represent, at least in part, the non-linear expression of RMS coil current or power versus operating frequency may be stored in memory. In one or more examples, the non-linear model expression is at least partially determined based on performing a least-squares method in relation to the sampled coil current values stored in association with the respective frequency points. In one or more specific examples, matrix and determinants are utilized to compute 2^{nd} order coefficients of the expression.

At an act 706, a non-linear expression of operating frequency versus RMS coil current or power is determined at least partially based on the sampled coil current values stored in association with the respective frequency points in act 702. In one or more examples, the non-linear expression is at least partially determined based on performing a least-squares method in relation to the sampled coil current values stored in association with the respective frequency points. In one or more specific examples, matrix and determinants are utilized to compute 2nd order coefficients of the expression. Alternatively in act 706, the non-linear model expression is determined at least partially based on the non-linear expression, or multiple parameters thereof, determined in act 704. The non-linear model expression may be stored in memory for subsequent use. For example, multiple parameters that represent, at least in part, the non-linear expression of operating frequency versus RMS coil current or power may be stored in memory.

At an act 708, a fundamental frequency, a lower frequency relative to the fundamental frequency, and an upper frequency relative to the fundamental frequency are determined. At least one of the lower frequency or the upper frequency is determined at least partially based on one or more of the non-linear expressions determined in acts 704 and 706. The fundamental frequency may be a predetermined fixed frequency which remains (relatively) unchanged over transmitter operation. Alternatively, the fundamental frequency may be a variable frequency which is selected or determined during normal operation of the transmitter (e.g., based on feedback from the receiver).

In one or more examples, the lower frequency may be determined relative to the fundamental frequency, for example, at least partially based on a predetermined minimum frequency spread at or relative to the fundamental frequency. In one or more specific examples, the lower frequency may be determined relative the fundamental frequency at least partially based on the predetermined minimum frequency spread using at least some discretion (e.g., the lower frequency may be offset from the fundamental frequency by a value that is equal to or greater than half of the predetermined minimum frequency spread, for example, within a certain percentage).

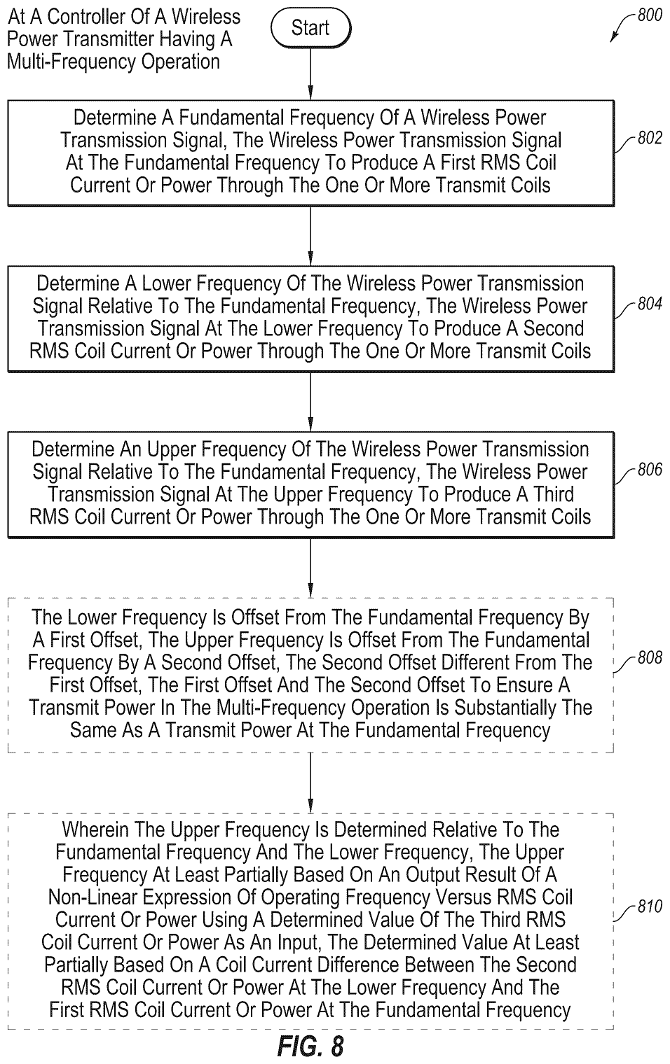

Then, in one or more examples, the upper frequency may be determined relative to the fundamental frequency and the lower frequency, at least partially based on one or more of the non-linear expressions determined in acts 704 and 706. The determinations of the fundamental frequency, the lower frequency, and the upper frequency are described in more detail herein, including in relation to FIGS. 8, 9, 10, 11, 12, and 13, according to one or more examples.

In one or more examples of the method of FIG. 7A, acts 704 and 706 are omitted, and the transmitter generates and stores a data table of RMS coil current versus operating frequency data (and/or operating frequency versus RMS coil current data) at least partially based on the sampled coil current values stored in association with the respective frequency points in act 702. The data table may be stored in memory for subsequent use in determining one or more of the fundamental frequency, the lower frequency, and the upper frequency in act 708. In one or more other examples of the method of FIG. 7A, the determined fundamental frequency, the determined lower frequency, and the determined upper frequency are stored in memory for use throughout operation of the transmitter, without maintaining storage and/or use of the non-linear expressions and/or data table. In one or more other examples, the determined fundamental frequency, the determined lower frequency, and the determined upper frequency are stored in memory for use, while continuing to maintain storage of the non-linear expressions and/or data table.

Subsequently, after the calibration process, the transmitter is to perform wireless power transfer using a multi-frequency operation that includes the fundamental frequency, the lower frequency, and the upper frequency. At an act 710, a wireless power transmission signal is generated in one or more transmit coils of the transmitter. At an act 712, an operating frequency of the wireless power transmission signal is controlled to repeatedly switch between the fundamental frequency and one of the lower frequency and the upper frequency in an alternating manner. At a characterization box 714, the lower frequency is offset from the fundamental frequency by a first offset, the upper frequency is offset from the fundamental frequency by a second offset, and the second offset is different from the first offset. The first offset associated with the lower frequency and the second offset associated with the upper frequency are set to ensure a transmit power in the multi-frequency operation is substantially the same as a transmit power at the fundamental frequency. The further characterizations may be the same as those described in relation to characterization box 606 of method 600 of FIG. 6.

FIG. 7B is a flowchart for describing a method 700B of configuring a wireless power transmitter for multi-frequency operation, according to one or more examples. Method 700B relates to the configuration of a wireless power transmitter having a variable fundamental frequency, which is selected or determined during normal operation of the transmitter (e.g., based on feedback from the receiver) after the calibration process. In one or more examples, the wireless power transmitter includes an L-C resonant circuitry exhibiting a non-linear relationship between operating frequency and transmit power (e.g., and/or the square of RMS coil current, and/or the RMS coil current).

The calibration process of acts 702, 704, and 706 of method 700B of FIG. 7B may be the same or substantially the same as those acts described in relation to method 700A of FIG. 7A. After the calibration process of acts 702, 704, and 706, the wireless power transmitter is to operate in normal operation.

Normal operation of the wireless power transmitter having the multi-frequency operation begins. The wireless power transmitter has a variable fundamental frequency which is selected or determined during normal operation (e.g., based on feedback from the receiver). Accordingly, at act 708, the wireless power transmitter is to determine the fundamental frequency, a lower frequency relative to the fundamental frequency, and an upper frequency relative to the fundamental frequency for multi-frequency operation. At least one of the lower frequency or the upper frequency may be determined at least partially based on one or more of the non-linear expressions determined in act 704 and act 706. Act 708 of method 700B of FIG. 7B may be the same or substantially the same as act 708 described in relation to method 700A of FIG. 7A.

Subsequently, the transmitter is to perform wireless power transfer in a multi-frequency operation that includes the fundamental frequency, the lower frequency, and the upper frequency. Act 710 and act 712 of method 700B (including characterization box 714) of FIG. 7B may be the same or substantially the same as act 710 and act 712 described in relation to method 700A (including characterization box 714) of FIG. 7A.

As the fundamental frequency is variable, at an act 716, the wireless power transmitter may identify that the fundamental frequency will change, or has changed, during operation. In one or more examples of act 716, the fundamental frequency may change according to one or more variables associated with various operating conditions. For example, the fundamental frequency may change to a new/updated fundamental frequency according to one or more variables which include receiver type, receiver coupling, and/or receiver load, when the one or more transmit coils of the transmitter are wirelessly coupled with one or more receive coils of the receiver. In one or more examples, a new/updated fundamental frequency may be determined, for example, at least partially in response to an indication in a communication received from the receiver. In one or more examples, the communication received from the receiver may be or include a control error signal or a control error packet (CEP), and the determination of the new/updated fundamental frequency may be made when the control error change in the CEP is zero (0) or nearly zero.

Accordingly, in (repeated) act 708, the wireless power transmitter is to determine the new/updated fundamental frequency, a new/updated lower frequency relative to the new/updated fundamental frequency, and a new/updated upper frequency relative to the new/updated fundamental frequency for multi-frequency operation. Note that act 708 may repeat for each detected change in the fundamental frequency at act 716. At least one of the new/updated lower frequency or the new/updated upper frequency is determined at least partially based on one or more of the non-linear expressions determined in acts 704 and 706. Again, in one or more examples, the new/updated lower frequency may be determined relative to the new/updated fundamental frequency, for example, at least partially based on the predetermined minimum frequency spread at or relative to the new/updated fundamental frequency. Then, in one or more examples, the new/updated upper frequency may be determined relative to the new/updated fundamental frequency and the new/updated lower frequency, at least partially based on one or more of the non-linear expressions determined in acts 704 and 706.

Subsequently, the transmitter is to again perform wireless power transfer in a multi-frequency operation, which now includes the new/updated fundamental frequency, the new/updated lower frequency, and the new/updated upper frequency. Thus again, at act 710, the wireless power transmission signal is generated in the one or more transmit coils and the operating frequency of the wireless power transmission signal is controlled to repeatedly switch between the new/updated fundamental frequency and one of the new/updated lower frequency and the new/updated upper frequency in the alternating manner.

In one or more other examples of method 700B, acts 704 and 706 are omitted, where the transmitter is to generate and store a data table of RMS coil current versus operating frequency data (and/or operating frequency versus RMS coil current data), at least partially based on the sampled coil current values stored in association with the respective frequency points in act 702. The data table may be stored in memory for subsequent use in determining the fundamental frequency, the lower frequency, and the upper frequency.

FIG. 8 is a flowchart describing a method 800 of configuring a wireless power transmitter for multi-frequency operation, according to one or more examples. Method 800 relates to the configuration of a wireless power transmitter having either a fixed fundamental frequency or a variable fundamental frequency which may be selected or determined during normal operation of the transmitter. In one or more examples, the determination of frequencies in method 800 may be performed during a calibration process or during normal operation of the wireless power transmitter. In one or more examples, the wireless power transmitter includes an L-C resonant circuitry exhibiting a non-linear relationship between operating frequency and transmit power (e.g., and/or the square of RMS coil current, and/or the RMS coil current).

At an act 802, a fundamental frequency of a wireless power transmission signal is determined. The wireless power transmission signal at the fundamental frequency is to produce a first RMS coil current or power through one or more transmit coils of the wireless power transmitter. In one or more examples, the fundamental frequency may be determined to be a fixed fundamental frequency or a variable fundamental frequency which is selected or determined during normal operation. In one or more examples, determining the fundamental frequency is at least partially based on an indication in a communication received from the wireless power receiver.

At an act 804, a lower frequency of the wireless power transmission signal is determined relative to the fundamental frequency. The lower frequency is offset from the fundamental frequency by a first offset. The wireless power transmission signal at the lower frequency is to produce a second RMS coil current or power through the one or more transmit coils. In one or more examples, the lower frequency may be determined at least partially based on a predetermined minimum frequency spread at or relative to the fundamental frequency.

At an act 806, an upper frequency of the wireless power transmission signal is determined relative to the fundamental frequency. The upper frequency is offset from the fundamental frequency by a second offset. The second offset associated with the upper frequency is different from the first offset associated with the lower frequency. The wireless power transmission signal at the upper frequency is to produce a third RMS coil current or power through the one or more transmit coils.

In one or more examples, the upper frequency may be determined relative to the fundamental frequency and the lower frequency to ensure an RMS coil current or power in the multi-frequency operation is substantially the same as the RMS coil current or power at the fundamental frequency.

Accordingly, at a characterization box 808, the first offset associated with the lower frequency and the second offset associated with the upper frequency are determined to ensure an RMS coil current or power in the multi-frequency operation is substantially the same as the RMS coil current or power at the fundamental frequency. In one or more examples of characterization box 808, the first offset associated with the lower frequency and the second offset associated with the upper frequency are determined to ensure that a square of an RMS coil current through the one or more transmit coils in the multi-frequency operation (e.g., as an approximation of the transmit power in the multi-frequency operation) is substantially the same as a square of the RMS coil current through the one or more transmit coils at the fundamental frequency (e.g., as an approximation of the transmit power at the fundamental frequency). In one or more other examples, the RMS coil current may be used as an approximation of the transmit power.

In one or more examples, in a characterization box 810 (e.g., associated with act 806), determining the upper frequency is at least partially based on an output result of a non-linear expression of operating frequency versus RMS coil current or power using a determined value of the third RMS coil current or power as an input. In one or more examples, multiple parameters that represent, at least in part, the non-linear expression of operating frequency versus RMS coil current or power may be stored in memory, and subsequently used to determine the upper frequency.

In one or more examples associated with characterization box 810 (e.g., and act 806), the determined value is at least partially based on a coil current difference between the second RMS coil current or power at the lower frequency and the first RMS coil current or power at the fundamental frequency. In one or more examples, the method further includes determining the determined value to be substantially equal or proportional to a difference between the first RMS coil current or power and the coil current difference between the second RMS coil current or power and the first RMS coil current or power. In one or more specific examples, the method further includes determining the first RMS coil current or power at least partially based on an output result of a non-linear expression of RMS coil current or power versus operating frequency using the fundamental frequency as an input, and determining the second RMS coil current or power at least partially based on an output result of the non-linear expression of RMS coil current or power versus operating frequency using the lower frequency as an input.

In one or more examples, the non-linear expression of operating frequency versus RMS coil current or power of the wireless power transmitter may be determined by performing a calibration process. The calibration process may include, at respective frequency points of multiple frequency points over a frequency range, generating a wireless power transmission signal at a respective frequency point, sampling a coil current through the one or more transmit coils produced from the wireless power transmission signal at the respective frequency point, and storing in memory a respective sampled coil current value in association with the respective frequency point. The calibration process may further include determining the non-linear expression of operating frequency versus RMS coil current or power at least partially based on sampled coil current values stored in association with the respective frequency points. In one or more examples, determining the non-linear expression of operating frequency versus RMS coil current is at least partially based on performing a least-squares method in relation to the sampled coil current values stored in association with the respective frequency points.

In one or more other examples, in act 806, determining the upper frequency is at least partially based on a data table lookup in a prestored data table of operating frequency versus RMS coil current or power of the wireless power transmitter using a determined value of the third RMS coil current or power as an index. The determined value is at least partially based on a coil current difference between the second RMS coil current or power at the lower frequency and the first RMS coil current or power at the fundamental frequency. In one or more examples, the prestored data table of operating frequency versus RMS coil current or power may be generated by performing a calibration process. The calibration process may include, of the wireless power transmitter, generating a wireless power transmission signal at a respective frequency point, sampling a coil current through the one or more transmit coils produced from the wireless power transmission signal at the respective frequency point, and storing in memory a respective sampled coil current value in association with the respective frequency point. The calibration process may further include generating the prestored data table of operating frequency versus RMS coil current or power at least partially based on sampled coil current values stored in association with the respective frequency points.

Although method 800 of FIG. 8 describes the determination of a frequency pattern including a fundamental frequency, a lower frequency, and an upper frequency, more generally the determined frequency pattern may include a fundamental frequency, one or more lower frequencies (e.g., multiple lower frequencies) relative to the fundamental frequency, and one or more upper frequencies (e.g., multiple upper frequencies) relative to the fundamental frequency, according to one or more examples. In one or more specific examples, the determination of the multiple lower frequencies and the multiple upper frequencies may be made using the same or similar non-linear expressions and calculations. In addition, although method 800 of FIG. 8 describes the determination of the lower frequency before the determination of the upper frequency, the method may alternatively provide for the determination of the upper frequency before the determination of the lower frequency (e.g., in a reverse fashion utilizing the same or similar non-linear expressions and calculations). Further, in one or more examples, respective ones of the non-linear expressions or relationships described in relation to method 800 of FIG. 8 may be represented or approximated by a piecewise linear function, and therefore the phrase “non-linear expression” is intended to encompass non-linear expressions, piecewise linear expressions or functions of the non-linear expressions, other linear approximations of the non-linear expressions, and equivalents thereof.

FIG. 9 is a flowchart of a method 900 of a calibration process for an N coil system of a wireless power transmitter, according to one or more examples. In one or more examples, the calibration process may be performed in relation to act 702 of method 700A of FIG. 7A and act 702 of method 700B of FIG. 7B. In one or more examples, the calibration process of method 900 is performed (e.g., only) once at the start of product life on a standalone basis.

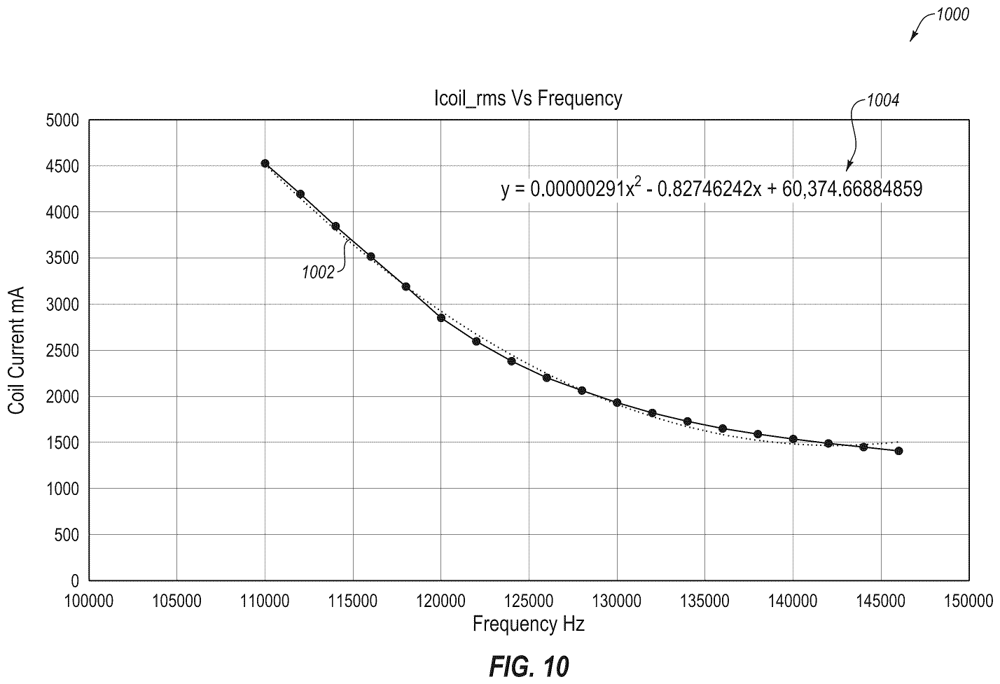

In general, each transmit coil in the coil array is subjected to a variable frequency (e.g., from lowest to highest) within a frequency range. At each frequency, capacitor voltage is measured and coil current is computed and tabulated (see, e.g., the previous discussion in relation to FIG. 2). This process may be repeated for respective ones of the transmit coils in the N coil system. The calibration data may be used to estimate the power that is transferred at a given frequency. Initially, the resonant frequency of the transmitter LC tank is set to 100 kHz, at which the gain or delivered power is the highest. From the peak, as the frequency increases, the gain or the power level decreases in a non-linear fashion (see, e.g., FIG. 10 and associated description).

More specifically in method 900, at an act 902, a transmit coil of the N coil system is selected (e.g., Coil 1). At an act 904, an operating frequency “f” of the transmitter is set to a minimum frequency fₘᵢₙ of the frequency range. At an act 906, a capacitor voltage V_{cap} is measured. At an act 908, a coil current I_{coil} is computed. At an act 910, the operating frequency f is incremented. If the operating frequency f is less than a maximum frequency fₘₐₓ of the frequency range, as tested at an act 912, then act 906 and act 908 are repeated at the incremented operating frequency f, and the operating frequency f is then again incremented at act 910 and again tested at act 912. When the operating frequency f is equal to or greater than the maximum frequency fₘₐₓ, as tested at an act 912, at an act 914, the transmit coil is incremented (i.e., the next transmit coil is selected). If the next transmit coil is less than the maximum number of coils N, as tested at an act 916, then the process is repeated for the next transmit coil in act 902, act 904, act 906, act 908, act 910, act 912, and act 914. When the next transmit coil is equal to or greater than the maximum number of coils N, as tested at act 916, the calibration process (or at least a portion of the calibration process for obtaining the calibration data points) is completed for the wireless power transmitter.

It is noted that one or more of a variety of different techniques may be used to determine the coil voltage amplitude for calculation of the coil current. In one or more examples, sampling of the voltage waveform may be performed using an averaging mode or process of the ADC. Here, multiple samples may be taken per signal period of voltage waveform and made available for processing (e.g., averaging). In order to prevent transients of the signal from influencing the averaging, sampling may be initiated after a delay from the beginning of the generation of the PWM signals. The samples may be spaced apart uniformly along the period of the PWM signal. In one or more examples, the average of samples may be available at the end and processed through use of an interrupt.

FIG. 10 is a plot 1000 of RMS coil current versus operating frequency, for example, calibration data points from a calibration process of a wireless power transmitter, according to one or more examples. In one or more examples, the calibration data may be obtained in relation to act 702 of method 700A of FIG. 7A; act 702 of method 700B of FIG. 7B; and/or method 900 of FIG. 9. In plot 1000, the calibration data points (indicated as small circles or dots in the figure) illustrate a non-linear relationship between RMS coil current and operating frequency of the transmitter.

A non-linear expression 1004 of RMS coil current versus operating frequency of the transmitter may be determined based on the calibration data points. The non-linear expression 1004 is to represent a continuous curve 1002 defining the non-linear relationship between the variables (i.e., the calibration data points are fit to continuous curve 1002 represented by the non-linear expression 1004). In one or more examples, the non-linear expression 1004 may be determined in relation to act 704 of method 700A of FIG. 7A and/or act 704 of method 700B of FIG. 7B. In one or more examples, the non-linear expression 1004 of RMS coil current versus operating frequency of the transmitter is determined to be y=0.00000291x²-0.82746242x+60,374.66884859, where x is the operating frequency and y is the RMS coil current. In one or more examples, such calibration data and/or non-linear expression may be utilized for the determination of a frequency pattern including a fundamental frequency and at least a lower frequency and an upper frequency.

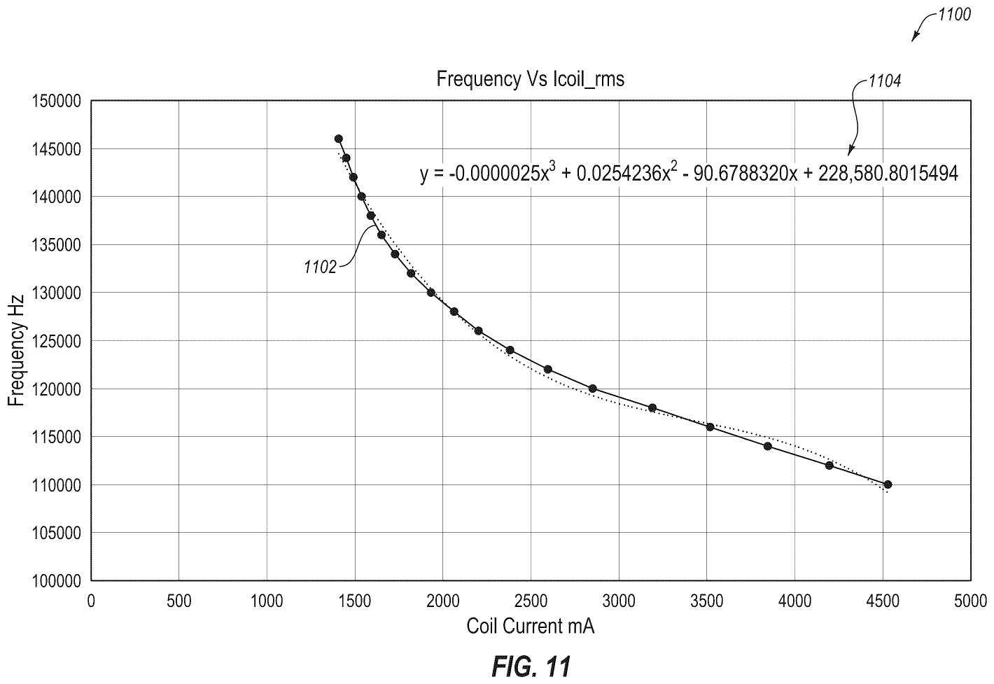

FIG. 11 is a plot 1100 of operating frequency versus RMS coil current for the example calibration data points from the calibration process of the wireless power transmitter, according to one or more examples. In one or more examples, the calibration data may be obtained in relation to act 702 of method 700A of FIG. 7A; act 702 of method 700B of FIG. 7B; and/or method 900 of FIG. 9. In plot 1100, the calibration data points (indicated as small circles or dots in the figure) may be the same data points as in plot 1000 of FIG. 10, with the x and the y axis switched, obtained from the same calibration process of the same transmitter. The calibration data points illustrate a non-linear relationship between operating frequency and RMS coil current of the transmitter.

A non-linear expression 1104 of operating frequency and RMS coil current of the transmitter may be determined based on the calibration data points. The non-linear expression 1104 is to represent a continuous curve 1102 defining the non-linear relationship between the variables (i.e., the calibration data points are fit to continuous curve 1102 represented by the non-linear expression 1104). In one or more examples, the non-linear expression 1104 may be determined in relation to act 704 of method 700A of FIG. 7A and/or act 704 of method 700B of FIG. 7B. In one or more examples, the non-linear expression 1104 of operating frequency and RMS coil current of the transmitter is determined to be y=−0.0000025x³+0.0254236x²−90.6788320x+228,580.8015494, where x is the RMS coil current and y is the operating frequency. In one or more examples, such calibration data and/or non-linear expression may be utilized for the determination of a frequency pattern including a fundamental frequency and at least a lower frequency and an upper frequency.

In one or more examples, the RMS coil current at a fundamental frequency may be used as a reference for the average power delivered to the receiver. Although the power delivered from the transmitter is proportional to the square of the RMS coil current, the RMS coil current may be used as an approximation of the power. As an alternative, plots may be obtained against the square of the RMS coil current, which may entail use of a higher-order filter to match the response. In any case, either the RMS coil current or its square may be used to represent the average power, and the choice of RMS coil current or its square may depend on desired accuracy and/or other variables.

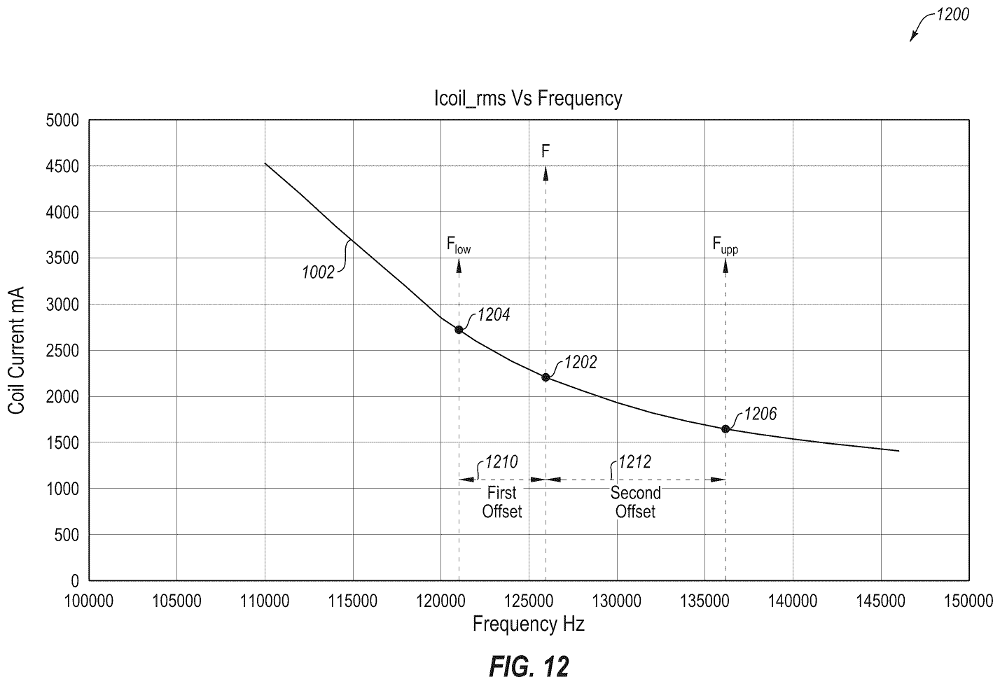

FIG. 12 is a graph 1200 of continuous curve 1002 of FIG. 10 based on the example calibration data points for describing an example selection of a frequency pattern for multi-frequency operation, according to one or more examples. Continuous curve 1002 represents the non-linear relationship between RMS coil current and operating frequency of the transmitter. In the example of FIG. 12, selected data points along continuous curve 1002 include a data point 1202 associated with a fundamental frequency (F), a data point 1204 associated with a lower frequency (Flow), and a data point 1206 associated with an upper frequency (Fᵤₚₚ).

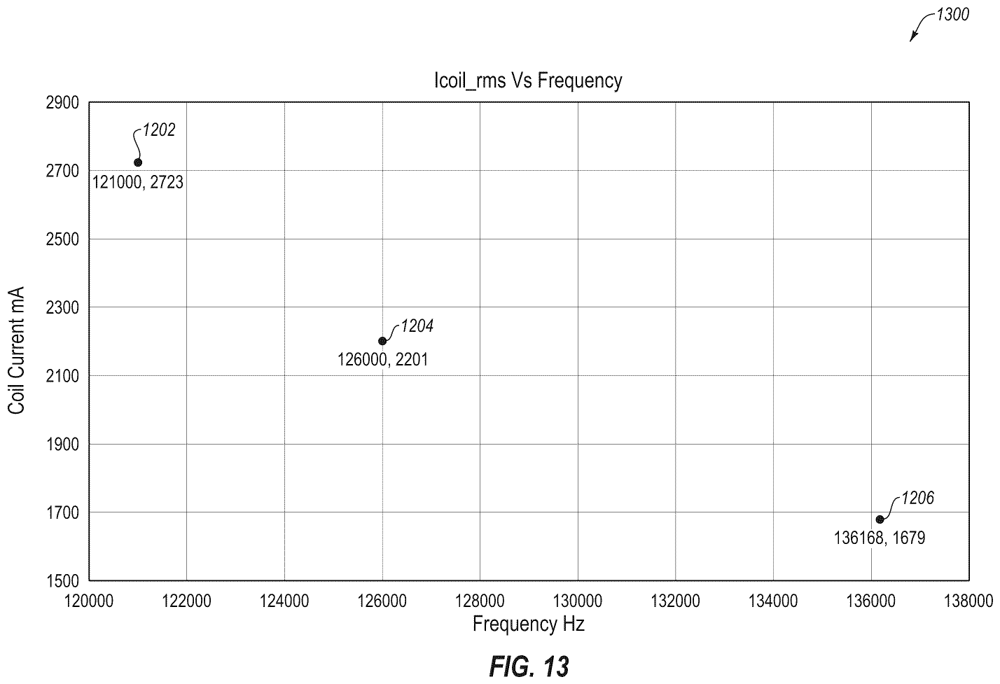

FIG. 13 is a plot 1300 of the selected data points of FIG. 12 including data point 1202, data point 1204, and data point 1206, with indication of the specific frequency and RMS coil current values associated with each data point.

With reference back to FIG. 12, the lower frequency Flow indicated by data point 1204 is shown to be offset from the fundamental frequency F by a first offset 1210 and the upper frequency Fᵤₚₚ indicated by data point 1206 is shown to be offset from the fundamental frequency F by a second offset 1212. The second offset 1212 is different from the first offset 1210.

The first offset 1210 of the lower frequency Flow and the second offset 1212 of the upper frequency Fᵤₚₚ are set to ensure a transmit power in the multi-frequency operation (e.g., repeated switching amongst F, Flow, and Fᵤₚₚ) is substantially the same as a transmit power at the fundamental frequency F. Put another way, the lower frequency Flow and the upper frequency Fᵤₚₚ are selected or determined to be offset asymmetrically relative to the fundamental frequency F to ensure the transmit power in the multi-frequency operation is substantially the same as the transmit power at the fundamental frequency F.

In general, the range of frequencies for multi-frequency operation may be determined based on the fundamental frequency, the spread of the pattern, the pattern update rate, and so on. In one or more examples, the selection or determination of the frequencies or offsets indicated in FIGS. 12 and 13 may be performed according to method 800 of FIG. 8 as previously described.

In the present example of FIGS. 12 and 13, the fundamental frequency F associated with data point 1202 is selected or determined to be 126 kHz. The fundamental frequency F of 126 kHz is associated with an RMS coil current of about 2.20 amperes (A).

The lower frequency Flow associated with data point 1204 may be determined relative to the fundamental frequency F, at least partially based on a predetermined minimum frequency spread at or relative to the fundamental frequency F. In the measurement setup for the CISPR 25 standard, for example, a bandwidth of 9 kHz is set for frequencies within the 150 kHz to 30 MHz range. Accordingly, in the present example, the predetermined minimum frequency spread for determining the adjacent frequency may be 9 kHz or greater (e.g., for accurate detection per CISPR 25). In one or more examples, the lower frequency Flow may be determined at least partially based on the predetermined minimum frequency spread using at least some discretion. For example, the lower frequency Flow may be offset from the fundamental frequency F by a value that is equal to or greater than half of the predetermined minimum frequency spread (e.g., within a certain percentage). In the present example of FIGS. 12 and 13, the offset (e.g., first offset 1210) for the lower frequency Flow is 9 kHz/2=4.5 kHz≈5 kHz, and therefore the lower frequency F_{low}=126 kHz-5 kHz=121 kHz.

Thus, the lower frequency Flow is selected to be 121 kHz, with the “delta frequency” or first offset 1210 between the fundamental frequency F (e.g., 126 kHz) and the lower frequency Flow being 5 kHz. The RMS coil current associated with the lower frequency Flow of 121 kHz may then be computed based on the non-linear expression 1004 of FIG. 10. As computed from the non-linear expression, the RMS coil current at the lower frequency Flow of 121 kHz is determined to be about 2.72 A. The difference in current (“delta current”) between the RMS coil current at the lower frequency Flow (e.g., about 2.72 A) and the RMS coil current at the fundamental frequency F (e.g., about 2.20 A) is computed to be 2.72 A-2.20 A=0.52 A.

The upper frequency Fᵤₚₚ associated with data point 1206 may be determined according to how far the delta current will extend the fundamental frequency F beyond the right side of the fundamental frequency F. The delta current (e.g., about 0.52 A) is subtracted from the RMS coil current of the fundamental frequency F (e.g., about 2.20 A), which is 2.20 A-0.52 A=1.68 A. The frequency associated with the RMS coil current of 1.68 A may be computed based on the non-linear expression 1104 of FIG. 11. As computed from the non-linear expression, the frequency associated with the RMS coil current of 1.68 A is determined to be 136 kHz. Thus, the upper frequency Fᵤₚₚ is determined to be 136 kHz, and the “delta frequency” or second offset 1212 between the upper frequency Fᵤₚₚ (e.g., 136 kHz) and the fundamental frequency F (e.g., 126 kHz) is 136 kHz-126 kHz=10 KHz.

In the present example of FIGS. 12 and 13, with use of techniques described in association with characterization box 810 of method 800 of FIG. 8, determining the upper frequency Fᵤₚₚ (e.g., about 136 kHz) is at least partially based on an output result of non-linear expression 1104 (FIG. 11) of operating frequency versus RMS coil current or power using a determined value of the RMS coil current or power at the upper frequency Fᵤₚₚ (e.g., about 1.68 A) as an input. In one or more examples, the determined value (e.g., about 1.68 A) is at least partially based on a coil current difference between the RMS coil current or power at the lower frequency Flow (e.g., about 2.72 A) and the RMS coil current or power at the fundamental frequency F (e.g., about 2.20 A) (e.g., 2.72 A-2.20 A=0.52 A). In one or more specific examples, the method includes determining the determined value of the RMS coil current or power at the upper frequency Fᵤₚₚ (e.g., about 1.68 A) to be substantially equal or proportional to a difference between the RMS coil current or power at the fundamental frequency F (e.g., about 2.20 A) and the coil current difference between the RMS coil current or power at the lower frequency Flow (e.g., about 2.72 A) and the RMS coil current or power at the fundamental frequency F (e.g., about 2.20 A) (e.g., 2.72 A-2.20 A=0.52 A) (e.g., determined value=2.20 A-0.52 A=1.68 A). In one or more specific examples, the method further includes determining the RMS coil current or power at the fundamental frequency F (e.g., about 2.20 A) at least partially based on an output result of non-linear expression 1004 (FIG. 10) of RMS coil current or power versus operating frequency using the fundamental frequency F (e.g., about 126 kHz) as an input, and/or determining the RMS coil current or power at the lower frequency Flow (e.g., about 2.72 A) at least partially based on an output result of non-linear expression 1004 (FIG. 10) of RMS coil current or power versus operating frequency using the lower frequency Flow (e.g., about 121 kHz) as an input.

The lower frequency Flow and the upper frequency Fᵤₚₚ are set to ensure a transmit power (e.g., based on the RMS coil current or its square) in the multi-frequency operation is substantially the same as a transmit power (e.g., based on the RMS coil current or its square) at the fundamental frequency F. Put another way, first offset 1210 of the lower frequency Flow and second offset 1212 of the upper frequency Fᵤₚₚ are set to ensure a transmit power in the multi-frequency operation is substantially the same as a transmit power at the fundamental frequency F.

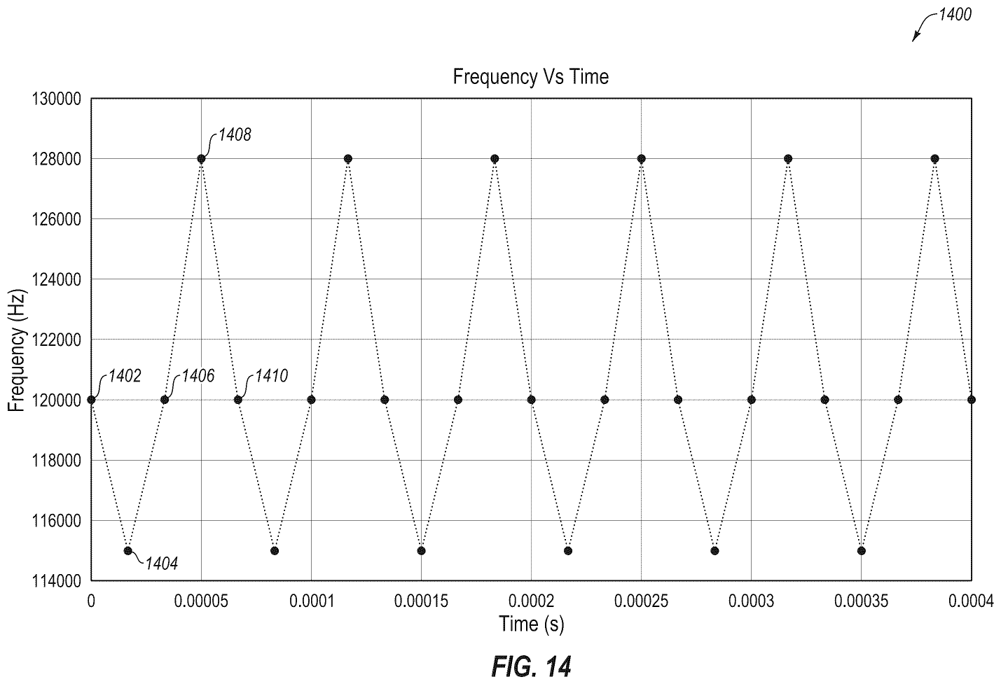

By determining the lower and the upper frequencies in the above-described manner, the RMS coil current or power level for wireless power transmission in the multi-frequency operation is maintained despite the non-linear relationship between RMS coil current (e.g., or its square, or transmit power) and operating frequency. In the example of FIGS. 12 and 13, the RMS coil current at the fundamental frequency F of 126 kHz is about 2.20 A, the RMS coil current at the lower frequency Flow of 121 kHz is about 2.72 A, and the RMS coil current at the upper frequency Fᵤₚₚ of 136 kHz is about 1.68 A. When wireless power transfer is performed at the fundamental frequency F of 126 kHz, the RMS coil current is about 2.20 A. When wireless power transfer is performed at the multi-frequency operation using the frequency pattern of 126 kHz, 121 kHz, and 136 kHz, the RMS coil current is substantially the same at about 2.23 A. The RMS coil current in the multi-frequency operation (e.g., using the repeated switching in the alternating manner; see the example of FIG. 14) may be calculated as the square root of ((2.722+2.202+1.682+2.202)/4)=2.23 A (which is approximately equal to 2.2 A). Thus, power balance over frequency is maintained.

Although the example of FIGS. 12 and 13 relates to the determination of a fundamental frequency F, a lower frequency Flow, and an upper frequency Fᵤₚₚ, more generally the frequency pattern may include a fundamental frequency, one or more lower frequencies (e.g., multiple lower frequencies) relative to the fundamental frequency, and one or more upper frequencies (e.g., multiple upper frequencies) relative to the fundamental frequency, according to one or more examples. In addition, respective ones of the non-linear expressions or relationships described in relation to the example of FIGS. 12 and 13 may be represented or approximated by a piecewise linear function in one or more examples, and therefore the phrase “non-linear expression” is intended to encompass non-linear expressions, piecewise linear expressions or functions of the non-linear expressions, other linear approximations of the non-linear expressions, and equivalents thereof.

The above examples describe an approach for determining frequencies for multi-frequency operation including determining a fundamental frequency, determining a lower frequency, and subsequently determining an upper frequency relative to the fundamental frequency and the lower frequency. However, alternative approaches may be utilized for determining the frequencies for multi-frequency operation. In one or more examples, an alternative approach may involve determining the fundamental frequency, determining an upper frequency, and subsequently determining a lower frequency relative to the fundamental frequency and the upper frequency, in the same or similar manner described in relation to the above-described methods and examples. In many cases, however, it is preferable to select the lower frequency prior to the upper frequency, as such selection more straightforwardly guarantees a predetermined minimum frequency spread. The reason is the non-linear expression curve is typically “steep” to the left of the fundamental frequency as compared to the right.

To illustrate using a first approach, consider the case where the fundamental frequency is 126 kHz and the predetermined minimum frequency spread is 9 kHz. The frequency spread may be generally divided in half (equally) to 4.5 kHz, and the lower frequency may be determined to be 121.5 kHz (e.g., 126 kHz-4.5 kHz=121.5 kHz). Based on the determined lower frequency, an upper frequency much further from the fundamental frequency than 4.5 kHz will be calculated using the non-linear expression, which thereby ensures the minimum spread of 9 kHz. On the other hand, if the upper frequency of 126 kHz+4.5 kHz=130.5 kHz were determined before the lower frequency, the lower frequency would be determined to be around 124 kHz, thereby providing a overall spread of only 6.5 kHz (i.e., less than the minimum spread of 9 kHz).

To illustrate using a second approach, consider again the case where the fundamental frequency is 126 kHz and the frequency spread is 9 kHz. Here, one could split the frequency spread into two unequal numbers, where the upper frequency is offset by a value greater than half of the frequency spread. For example, providing an offset for the upper frequency to be 7 kHz (7 kHz>(9 kHz/2)=4.5 kHz). After calculation of the lower frequency using the non-linear expression, one would end up with a frequency spread greater than 9 kHz. Since the slope is different at different fundamental frequencies, the first approach of splitting equally and determining the lower frequency before the upper frequency is preferred and works at many, most or all frequencies.

In one or more examples, as an extension of the first approach, a “back-and-forth” approach based on the first approach may be utilized, upon determining that the separation between the lower frequency and the upper frequency is too large relative to the frequency spread. In this more refined approach, after the lower frequency and the upper frequency are determined and the separation between the lower frequency and the upper frequency is determined to be too large relative to the frequency spread, a new lower frequency that is closer to the fundamental frequency may be determined and a new upper frequency may be calculated according to the new lower frequency. This redetermination and recalculation may be repeated if and as needed. For example, with reference to the example of FIGS. 12 and 13, after the lower frequency Flow and the upper frequency Fᵤₚₚ were determined, the frequency pattern is identified to be actually separated by about 15 kHz (i.e., 136 kHz-121 kHz=15 kHz) as compared to the predetermined minimum frequency spread being 9 kHz. In one or more examples, the separation may be reduced by determining a new lower frequency Flow that is closer to the fundamental frequency F (e.g., select 122 kHz instead of 121 kHz) and calculating a new upper frequency Fᵤₚₚ according to the new lower frequency Flow.

FIG. 14 is a plot 1400 of example data points of operating frequency versus time for a wireless power transmission signal during multi-frequency operation, according to one or more examples. Plot 1400 of FIG. 14 illustrates that, during the multi-frequency operation, the operating frequency of the wireless power transmission signal may be repeatedly switched between a fundamental frequency and one of a lower frequency and an upper frequency in an alternating manner, in one or more examples. For example, the operating frequency is switched from a fundamental frequency (e.g., at a data point 1402, indicated at 120 kHz) to a lower frequency (e.g., at a data point 1404, indicated at 115 kHz) and then back to the fundamental frequency (e.g., at a data point 1406, indicated at 120 kHz), and from the fundamental frequency to an upper frequency (e.g., at a data point 1408, indicated at 128 kHz) and then back to the fundamental frequency (e.g., at a data point 1410, indicated at 120 kHz), and so on, in a repeated alternating manner. The operating frequency may be controlled to repeatedly switch in the alternating manner at a predetermined rate (e.g., a predetermined rate of greater than or equal to 20 kHz). In this example, the spread or range of the frequency pattern is about 13 kHz (128 kHz-115 kHz=13 kHz).

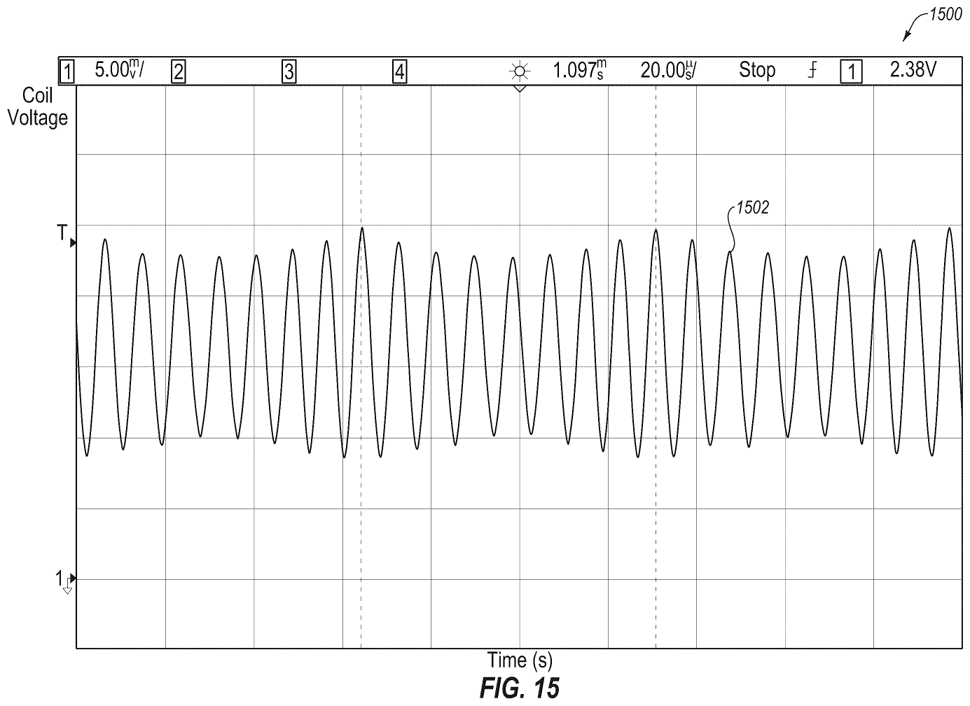

FIG. 15 is a graph 1500 of a coil voltage signal 1502 at an input of the ADC during multi-frequency operation, according to one or more examples. In the multi-frequency operation, the frequency pattern is applied to the PWM signal every alternate cycle. A four (4)-point pattern takes about eight (8) cycles at the fundamental frequency, leading to an update rate of around 120 KHz/8=15 kHz. In one or more examples, the frequency pattern can be applied to every PWM cycle for a higher update rate, thereby shifting away from the audible frequency band. In one or more examples, the pattern update rate is greater than 20 kHz to avoid generation of audible noise by the transmitter.

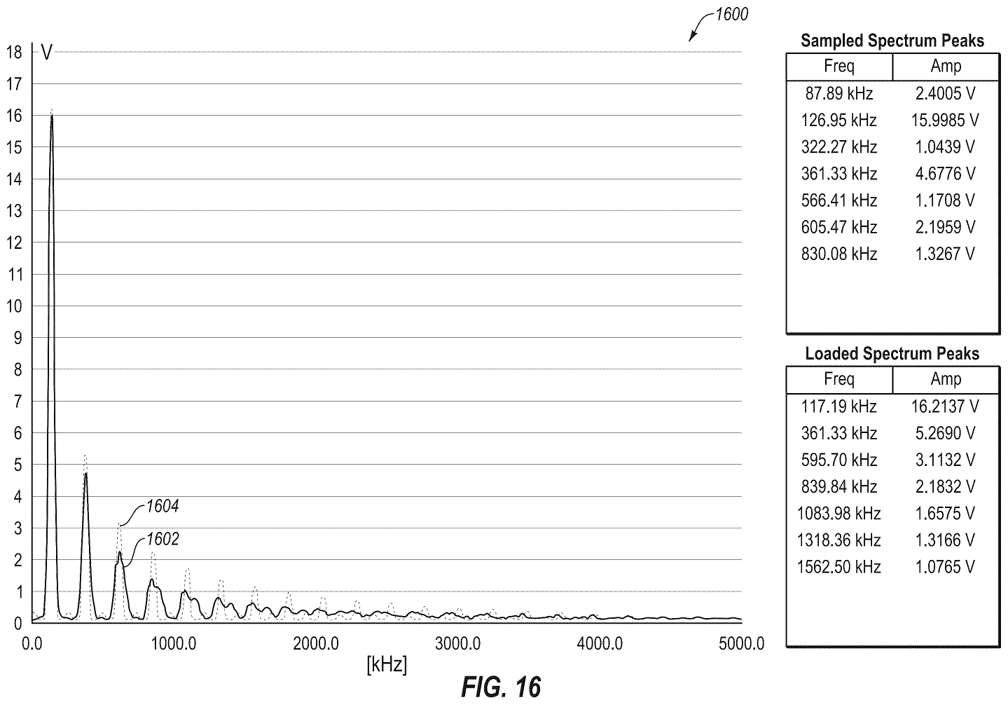

FIG. 16 is a graph 1600 of receiver voltage spectrum versus frequency of a wireless power transmitter with and without frequency dithering enabled, according to one or more examples. A first curve 1602 is the receiver voltage spectrum versus frequency with frequency dithering enabled, and a second curve 1604 is the receiver voltage spectrum versus frequency without frequency dithering enabled. In FIG. 16, it is indicated that a fundamental frequency is split into a lower frequency of 87 kHz, and its harmonics are split into multiple frequencies (due to which radiation is not concentrated at a single frequency). As is apparent from comparing first curve 1602 (frequency dithering enabled) and second curve 1604 (frequency dithering disabled), undesired emitted radiation may be reduced with use of the multi-frequency operation described herein.

One or more advantages may be realized depending on the one or more example features chosen for the multi-frequency operation. In one or more examples, the transmitter having the multi-frequency operation of the disclosure may be configured to pass (e.g., even stringent) emissions tests, even when all other options have been exhausted (e.g., even without requiring a redesign of transmitter hardware). In one or more examples, wireless power transfer according to the multi-frequency operation is guaranteed under a wide range of conditions of load and input voltage and different receiver types. In one or more examples, a software algorithm(s) may be utilized to achieve the (e.g., entire) desired multi-frequency operation, and therefore additional hardware components may not be necessary (e.g., unless desired according to specific operating conditions). In one or more examples, the transmitter hardware design for achieving the multi-frequency operation for reduced emissions may be of low complexity.

The above-described examples may be embodied as a computer program product comprising a data storage device and machine-executable code in the data storage device, where the machine-executable code includes executable instructions to adapt or enable a processor (e.g., controller, microcontroller, and so on) to perform any one of the techniques. Also, an apparatus may comprise a processor (e.g., controller, microcontroller, and so on) and a data storage device to store machine-executable code including executable instructions to adapt or enable the processor to perform any one of the techniques.

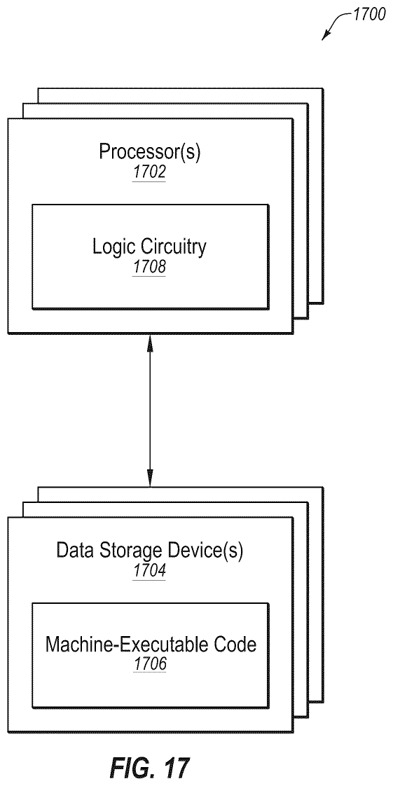

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 17 illustrates non-limiting examples of implementations of functional elements disclosed herein. In some examples, some or all portions of the functional elements disclosed herein may be performed by hardware specially implemented for carrying out the functional elements.

FIG. 17 is a block diagram of circuitry 1700 that, in some examples, may be used to implement various functions, operations, acts, processes, and/or methods disclosed herein. The circuitry 1700 includes one or more processors 1702 (sometimes referred to herein as “processors 1702”) operably coupled to one or more data storage devices (sometimes referred to herein as “storage 1704”). The storage 1704 includes machine-executable code 1706 stored thereon and the processors 1702 include logic circuitry 1708. The machine-executable code 1706 includes information describing functional elements that may be implemented by (e.g., performed by) the logic circuitry 1708. The logic circuitry 1708 is adapted to implement (e.g., perform) the functional elements described by the machine-executable code 1706. The circuitry 1700, when executing the functional elements described by the machine-executable code 1706, should be considered as special purpose hardware for carrying out functional elements disclosed herein. In some examples the processors 1702 may be to perform the functional elements described by the machine-executable code 1706 sequentially, concurrently (e.g., on one or more different hardware platforms), or in one or more parallel process streams.

When implemented by logic circuitry 1708 of the processors 1702, the machine-executable code 1706 is to adapt the processors 1702 to perform operations of examples disclosed herein. For example, the machine-executable code 1706 may be to adapt the processors 1702 to perform at least a portion or a totality of the method of FIG. 6, the method of FIG. 7A, the method of FIG. 7B, the method of FIG. 8, and the method of FIG. 9, and other related techniques and features described herein. As another example, the machine-executable code 1706 may be to adapt the processors 1702 to perform at least a portion or a totality of the operations discussed for the controller of FIG. 2.

The processors 1702 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is to execute functional elements corresponding to the machine-executable code 1706 (e.g., software code, firmware code, hardware descriptions) related to examples of the present disclosure. It is noted that a general-purpose processor (may also be referred to herein as a host processor or simply a host) may be a microprocessor, but in the alternative, the processors 1702 may include any conventional processor, controller, microcontroller, or state machine. The processors 1702 may also be implemented as a combination of computing devices, such as a combination of a DSP and a microprocessor, a plurality of microprocessors, one or more microprocessors in conjunction with a DSP core, or any other such configuration.

In some examples, the storage 1704 includes volatile data storage (e.g., random-access memory (RAM)), non-volatile data storage (e.g., Flash memory, a hard disc drive, a solid-state drive, erasable programmable read-only memory (EPROM), and so on). In some examples the processors 1702 and the storage 1704 may be implemented into a single device (e.g., a semiconductor device product, a system on chip (SOC), and so on). In some examples the processors 1702 and the storage 1704 may be implemented into separate devices.

In some examples, the machine-executable code 1706 may include computer-readable instructions (e.g., software code, firmware code). By way of non-limiting example, the computer-readable instructions may be stored by the storage 1704, accessed directly by the processors 1702, and executed by the processors 1702 using at least the logic circuitry 1708. Also, by way of non-limiting example, the computer-readable instructions may be stored on the storage 1704, transferred to a memory device (not shown) for execution, and executed by the processors 1702 using at least the logic circuitry 1708. Accordingly, in some examples the logic circuitry 1708 includes electrically configurable logic circuitry 1708.

In some examples, the machine-executable code 1706 may describe hardware (e.g., circuitry) to be implemented in the logic circuitry 1708 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large-scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 1708 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 1706 may include an HDL, an RTL, a GL description, a mask level description, other hardware description, or any combination thereof.

In examples where the machine-executable code 1706 includes a hardware description (at any level of abstraction), a system (not shown, but including the storage 1704) may be to implement the hardware description described by the machine-executable code 1706. By way of non-limiting example, the processors 1702 may include a programmable logic device (e.g., an FPGA or a PLC) and the logic circuitry 1708 may be electrically controlled to implement circuitry corresponding to the hardware description into the logic circuitry 1708. Also, by way of non-limiting example, the logic circuitry 1708 may include hard-wired logic manufactured by a manufacturing system (not shown but including the storage 1704) according to the hardware description of the machine-executable code 1706.

Regardless of whether the machine-executable code 1706 includes computer-readable instructions or a hardware description, the logic circuitry 1708 is adapted to perform the functional elements described by the machine-executable code 1706 when implementing the functional elements of the machine-executable code 1706. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, and so on) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” and so on).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

A non-exhaustive, non-limiting list of examples follows. Not each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.

Additional non-limiting examples of the disclosure include:

Example 1: A method comprising: generating a wireless power transmission signal in one or more transmit coils of a wireless power transmitter; and in a multi-frequency operation of the wireless power transmitter, controlling an operating frequency of the wireless power transmission signal to repeatedly switch between a fundamental frequency and one of a lower frequency and an upper frequency in an alternating manner, the lower frequency offset from the fundamental frequency by a first offset, the upper frequency offset from the fundamental frequency by a second offset, the second offset different from the first offset, the first offset and the second offset to ensure a transmit power in the multi-frequency operation is substantially the same as a transmit power at the fundamental frequency.

Example 2: The method according to Example 1, wherein the wireless power transmitter comprises an inductor-capacitor (L-C) resonant circuitry to exhibit a non-linear relationship between the operating frequency and the transmit power.

Example 3: The method according to any of Examples 1 and 2, wherein the first offset associated with the lower frequency and the second offset associated with the upper frequency are to ensure a square of a root mean square (RMS) coil current through the one or more transmit coils in the multi-frequency operation is substantially the same as a square of an RMS coil current through the one or more transmit coils at the fundamental frequency.

Example 4: The method according to any of Examples 1 through 3, wherein the first offset associated with the lower frequency and the second offset associated with the upper frequency are to ensure a root mean square (RMS) coil current through the one or more transmit coils in the multi-frequency operation is substantially the same as an RMS coil current through the one or more transmit coils at the fundamental frequency.

Example 5: The method according to any of Examples 1 through 4, comprising: determining the fundamental frequency; determining the lower frequency relative to the fundamental frequency; and determining the upper frequency relative to the fundamental frequency and the lower frequency, the determining of the upper frequency at least partially based on an output result of a non-linear expression of operating frequency versus RMS coil current or power of the wireless power transmitter using a determined value of an RMS coil current or power at the upper frequency as an input, the determined value at least partially based on a coil current difference between an RMS coil current or power at the lower frequency and an RMS coil current or power at the fundamental frequency.

Example 6: The method according to any of Examples 1 through 5, comprising: storing, in memory, multiple parameters that represent, at least in part, the non-linear expression of operating frequency versus RMS coil current or power of the wireless power transmitter.

Example 7: The method according to any of Examples 1 through 6, wherein the determined value is substantially equal or proportional to a difference between the RMS coil current or power at the fundamental frequency and the coil current difference between the RMS coil current or power at the lower frequency and the RMS coil current or power at the fundamental frequency.

Example 8: The method according to any of Examples 1 through 7, comprising: determining the RMS coil current or power at the fundamental frequency at least partially based on an output result of a non-linear expression of RMS coil current or power versus operating frequency using the fundamental frequency as an input; and determining the RMS coil current or power at the lower frequency at least partially based on an output result of the non-linear expression of RMS coil current or power versus operating frequency using the lower frequency as an input.

Example 9: The method according to any of Examples 1 through 8, wherein determining the fundamental frequency comprises: determining the fundamental frequency comprising a predetermined fixed frequency of the wireless power transmitter.

Example 10: The method according to any of Examples 1 through 9, wherein the one or more transmit coils of the wireless power transmitter is to wirelessly couple with one or more receive coils of a wireless power receiver for wireless power transfer, and wherein determining the fundamental frequency comprises: determining the fundamental frequency at least partially based on an indication in a communication received from the wireless power receiver.

Example 11: The method according to any of Examples 1 through 10, wherein determining the lower frequency comprises: determining the lower frequency at least partially based on a predetermined minimum frequency spread at or relative to the fundamental frequency.

Example 12: The method according to any of Examples 1 through 11, wherein controlling the operating frequency of the wireless power transmission signal comprises controlling the operating frequency of the wireless power transmission signal to repeatedly switch in the alternating manner at a rate of greater than or equal to 20 kilohertz (kHz).

Example 13: An apparatus comprising: a wireless power transmitter comprising: a transmitter circuitry, the transmitter circuitry including one or more transmit coils to inductively couple with one or more receive coils of a wireless power receiver; and a controller operably coupled to the transmitter circuitry, the controller to control the transmitter circuitry to generate a wireless power transmission signal in the one or more transmit coils for wireless power transfer, including controlling an operating frequency of the wireless power transmission signal to repeatedly switch between a fundamental frequency and one of a lower frequency and an upper frequency in an alternating manner in a multi-frequency operation, the lower frequency offset from the fundamental frequency by a first offset, an upper frequency offset from the fundamental frequency by a second offset, the second offset different from the first offset, the first offset and the second offset to ensure a transmit power in the multi-frequency operation is substantially the same as a transmit power at the fundamental frequency.

Example 14: The apparatus according to Example 13, wherein the transmitter circuitry comprises an inductor-capacitor (L-C) resonant circuitry to exhibit a non-linear relationship between the operating frequency and the transmit power.

Example 15: The apparatus according to any of Examples 13 and 14, wherein the first offset associated with the lower frequency and the second offset associated with the upper frequency to ensure a root mean square (RMS) coil current through the one or more transmit coils in the multi-frequency operation is substantially the same as an RMS coil current through the one or more transmit coils at the fundamental frequency.

Example 16: The apparatus according to any of Examples 13 through 15, wherein: the controller is to: determine the fundamental frequency; determine the lower frequency relative to the fundamental frequency; and determine the upper frequency relative to the fundamental frequency and the lower frequency, the determining of the upper frequency at least partially based on an output result of a non-linear expression of operating frequency versus RMS coil current or power of the wireless power transmitter using a determined value of an RMS coil current or power at the upper frequency as an input, the determined value at least partially based on a coil current difference between the RMS coil current or power at the lower frequency and an RMS coil current or power at the fundamental frequency.

Example 17: The apparatus according to any of Examples 13 through 16, wherein: the wireless power transmitter comprises: a memory, the memory to store multiple parameters that represent, at least in part, a non-linear expression of operating frequency versus RMS coil current or power of the wireless power transmitter.

Example 18: The apparatus according to any of Examples 13 through 17, wherein the determined value is substantially equal or proportional to a difference between the RMS coil current or power at the fundamental frequency and the coil current difference between the RMS coil current or power at the lower frequency and the RMS coil current or power at the fundamental frequency.

Example 19: The apparatus according to any of Examples 13 through 18, wherein: the controller is to: determine the RMS coil current or power at the fundamental frequency at least partially based on an output result of a non-linear expression of RMS coil current or power versus operating frequency using the fundamental frequency as an input; and determine the RMS coil current or power at the lower frequency at least partially based on an output result of the non-linear expression of RMS coil current or power versus operating frequency using the lower frequency as an input.

Example 20: A method comprising: at a controller of a wireless power transmitter having a multi-frequency operation: determining a fundamental frequency of a wireless power transmission signal, the wireless power transmission signal at the fundamental frequency to produce a first root mean square (RMS) coil current or power through one or more transmit coils of the wireless power transmitter; determining a lower frequency of the wireless power transmission signal relative to the fundamental frequency, the lower frequency offset from the fundamental frequency by a first offset, the wireless power transmission signal at the lower frequency to produce a second RMS coil current or power through the one or more transmit coils; and determining an upper frequency of the wireless power transmission signal relative to the fundamental frequency, the upper frequency offset from the fundamental frequency by a second offset, the second offset different from the first offset, the wireless power transmission signal at the upper frequency to produce a third RMS coil current or power through the one or more transmit coils, the first offset associated with the lower frequency and the second offset associated with the upper frequency to ensure an RMS coil current or power in the multi-frequency operation is substantially the same as the first RMS coil current or power at the fundamental frequency.

Example 21: The method according to Example 20, wherein the wireless power transmitter includes inductor-capacitor (L-C) resonant circuitry to exhibit a non-linear relationship between operating frequency and transmit power.

Example 22: The method according to any of Examples 20 and 21, wherein determining the upper frequency comprises: determining the upper frequency relative to the fundamental frequency and the lower frequency, the determining of the upper frequency at least partially based on an output result of a non-linear expression of operating frequency versus RMS coil current or power using a determined value of the third RMS coil current or power as an input, the determined value at least partially based on a coil current difference between the second RMS coil current or power at the lower frequency and the first RMS coil current or power at the fundamental frequency.

Example 23: The method according to any of Examples 20 through 22, comprising: at the controller of the wireless power transmitter, determining the determined value to be substantially equal or proportional to a difference between the first RMS coil current or power and the coil current difference between the second RMS coil current or power and the first RMS coil current or power.

Example 24: The method according to any of Examples 20 through 23, comprising: at the controller of the wireless power transmitter, determining the first RMS coil current or power at least partially based on an output result of a non-linear expression of RMS coil current or power versus operating frequency using the fundamental frequency as an input; and determining the second RMS coil current or power at least partially based on an output result of the non-linear expression of RMS coil current or power versus operating frequency using the lower frequency as an input.

Example 25: The method according to any of Examples 20 through 24, comprising: at the wireless power transmitter, storing, in memory, multiple parameters that represent, at least in part, the non-linear expression of operating frequency versus RMS coil current or power of the wireless power transmitter.

Example 26: The method according to any of Examples 20 through 25, wherein the one or more transmit coils of the wireless power transmitter is to wirelessly couple with one or more receive coils of a wireless power receiver, and wherein determining the fundamental frequency comprises: determining the fundamental frequency at least partially based on an indication in a communication received from the wireless power receiver.

Example 27: The method according to any of Examples 20 through 26, wherein determining the lower frequency comprises: determining the lower frequency at least partially based on a predetermined minimum frequency spread at or relative to the fundamental frequency.

Example 28: The method according to any of Examples 20 through 27, comprising: at the controller of the wireless power transmitter, performing a calibration process comprising: at respective frequency points of multiple frequency points over a frequency range, generating a wireless power transmission signal at a respective frequency point, sampling a coil current through the one or more transmit coils produced from the wireless power transmission signal at the respective frequency point, and storing in memory a respective sampled coil current value in association with the respective frequency point; and determining the non-linear expression of operating frequency versus RMS coil current or power at least partially based on sampled coil current values stored in association with the respective frequency points.

Example 29: The method according to any of Examples 20 through 28, wherein determining the non-linear expression of operating frequency versus RMS coil current is at least partially based on performing a least-squares method in relation to the sampled coil current values stored in association with the respective frequency points.

Example 30: The method according to any of Examples 20 through 29, wherein determining the upper frequency comprises: determining the upper frequency relative to the fundamental frequency and the lower frequency, the determining of the upper frequency at least partially based on a data table lookup in a prestored data table of operating frequency versus RMS coil current or power of the wireless power transmitter using a determined value of the third RMS coil current or power as an index, the determined value at least partially based on a difference between the second RMS coil current or power at the lower frequency and the first RMS coil current or power at the fundamental frequency.

Example 31: The method according to any of Examples 20 through 30, comprising: at the controller of the wireless power transmitter, performing a calibration process comprising: at respective frequency points of multiple frequency points over a frequency range, generating a wireless power transmission signal at a respective frequency point, sampling a coil current through the one or more transmit coils produced from the wireless power transmission signal at the respective frequency point, and storing in memory a respective sampled coil current value in association with the respective frequency point; and generating the prestored data table of operating frequency versus RMS coil current or power at least partially based on sampled coil current values stored in association with the respective frequency points.

Example 32: The method according to any of Examples 20 through 31, comprising: at the controller of the wireless power transmitter, generating the wireless power transmission signal at the fundamental frequency, at the lower frequency, and at the upper frequency.

Example 33: The method according to any of Examples 20 through 32, comprising: at the controller of the wireless power transmitter, generating the wireless power transmission signal; and controlling an operating frequency of the wireless power transmission signal to repeatedly switch between the fundamental frequency and one of the lower frequency and the upper frequency in an alternating manner.

Example 34: The method according to any of Examples 20 through 33, wherein controlling the operating frequency of the wireless power transmission signal comprises controlling the operating frequency of the wireless power transmission signal to repeatedly switch in the alternating manner at a rate of greater than or equal to 20 kilohertz (kHz).

Example 35: An apparatus comprising: a wireless power transmitter comprising: a transmitter circuitry, the transmitter circuitry including one or more transmit coils to inductively couple with one or more receive coils of a wireless power receiver; and a controller operably coupled to the transmitter circuitry, the controller to: determine a fundamental frequency of a wireless power transmission signal, the wireless power transmission signal at the fundamental frequency to produce a first root mean square (RMS) coil current or power through the one or more transmit coils; determine a lower frequency of the wireless power transmission signal relative to the fundamental frequency, the lower frequency offset from the fundamental frequency by a first offset, the wireless power transmission signal at the lower frequency to produce a second RMS coil current or power through the one or more transmit coils; and determine an upper frequency of the wireless power transmission signal relative to the fundamental frequency, the upper frequency offset from the fundamental frequency by a second offset, the second offset different from the first offset, the wireless power transmission signal at the upper frequency to produce a third RMS coil current or power through the one or more transmit coils, the first offset associated with the lower frequency and the second offset associated with the upper frequency to ensure an RMS coil current or power in a multi-frequency operation is substantially the same as the first RMS coil current or power at the fundamental frequency.

Example 36: The apparatus according to Example 35, wherein the transmitter circuitry includes inductor-capacitor (L-C) resonant circuitry to exhibit a non-linear relationship between operating frequency and transmit power.

Example 37: The apparatus according to any of Examples 35 and 36, wherein the controller is to: determine the upper frequency relative to the fundamental frequency and the lower frequency, the determining of the upper frequency at least partially based on an output result of a non-linear expression of operating frequency versus RMS coil current or power using a determined value of the third RMS coil current or power as an input, the determined value at least partially based on a difference between the second RMS coil current or power at the lower frequency and the first RMS coil current or power at the fundamental frequency.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method comprising:
generating a wireless power transmission signal in one or more transmit coils of a wireless power transmitter; and
in a multi-frequency operation of the wireless power transmitter, controlling an operating frequency of the wireless power transmission signal to repeatedly switch between a fundamental frequency and one of a lower frequency and an upper frequency in an alternating manner, the lower frequency offset from the fundamental frequency by a first offset, the upper frequency offset from the fundamental frequency by a second offset, the second offset different from the first offset, the first offset and the second offset to ensure a transmit power in the multi-frequency operation is substantially the same as a transmit power at the fundamental frequency.

2. The method of claim 1, wherein the wireless power transmitter comprises an inductor-capacitor (L-C) resonant circuitry to exhibit a non-linear relationship between the operating frequency and the transmit power.

3. The method of claim 1, wherein the first offset associated with the lower frequency and the second offset associated with the upper frequency are to ensure a square of a root mean square (RMS) coil current through the one or more transmit coils in the multi-frequency operation is substantially the same as a square of an RMS coil current through the one or more transmit coils at the fundamental frequency.

4. The method of claim 1, wherein the first offset associated with the lower frequency and the second offset associated with the upper frequency are to ensure a root mean square (RMS) coil current through the one or more transmit coils in the multi-frequency operation is substantially the same as an RMS coil current through the one or more transmit coils at the fundamental frequency.

5. The method of claim 4, comprising:
determining the fundamental frequency;
determining the lower frequency relative to the fundamental frequency; and
determining the upper frequency relative to the fundamental frequency and the lower frequency, the determining of the upper frequency at least partially based on an output result of a non-linear expression of operating frequency versus RMS coil current or power of the wireless power transmitter using a determined value of an RMS coil current or power at the upper frequency as an input, the determined value at least partially based on a coil current difference between an RMS coil current or power at the lower frequency and an RMS coil current or power at the fundamental frequency.

6. The method of claim 5, comprising:
storing, in memory, multiple parameters that represent, at least in part, the non-linear expression of operating frequency versus RMS coil current or power of the wireless power transmitter.

7. The method of claim 5, wherein the determined value is substantially equal or proportional to a difference between the RMS coil current or power at the fundamental frequency and the coil current difference between the RMS coil current or power at the lower frequency and the RMS coil current or power at the fundamental frequency.

8. The method of claim 7, comprising:
determining the RMS coil current or power at the fundamental frequency at least partially based on an output result of a non-linear expression of RMS coil current or power versus operating frequency using the fundamental frequency as an input; and
determining the RMS coil current or power at the lower frequency at least partially based on an output result of the non-linear expression of RMS coil current or power versus operating frequency using the lower frequency as an input.

9. The method of claim 5, wherein determining the fundamental frequency comprises:
determining the fundamental frequency comprising a predetermined fixed frequency of the wireless power transmitter.

10. The method of claim 5, wherein the one or more transmit coils of the wireless power transmitter is to wirelessly couple with one or more receive coils of a wireless power receiver for wireless power transfer, and wherein determining the fundamental frequency comprises:
determining the fundamental frequency at least partially based on an indication in a communication received from the wireless power receiver.

11. The method of claim 5, wherein determining the lower frequency comprises:
determining the lower frequency at least partially based on a predetermined minimum frequency spread at or relative to the fundamental frequency.

12. The method of claim 1, wherein controlling the operating frequency of the wireless power transmission signal comprises controlling the operating frequency of the wireless power transmission signal to repeatedly switch in the alternating manner at a rate of greater than or equal to 20 kilohertz (kHz).

13. An apparatus comprising:
a wireless power transmitter comprising:
a transmitter circuitry, the transmitter circuitry including one or more transmit coils to inductively couple with one or more receive coils of a wireless power receiver; and
a controller operably coupled to the transmitter circuitry, the controller to control the transmitter circuitry to generate a wireless power transmission signal in the one or more transmit coils for wireless power transfer, including controlling an operating frequency of the wireless power transmission signal to repeatedly switch between a fundamental frequency and one of a lower frequency and an upper frequency in an alternating manner in a multi-frequency operation, the lower frequency offset from the fundamental frequency by a first offset, the upper frequency offset from the fundamental frequency by a second offset, the second offset different from the first offset, the first offset and the second offset to ensure a transmit power in the multi-frequency operation is substantially the same as a transmit power at the fundamental frequency.

14. The apparatus of claim 13, wherein the transmitter circuitry comprises an inductor-capacitor (L-C) resonant circuitry to exhibit a non-linear relationship between the operating frequency and the transmit power.

15. The apparatus of claim 13, wherein the first offset associated with the lower frequency and the second offset associated with the upper frequency to ensure a root mean square (RMS) coil current through the one or more transmit coils in the multi-frequency operation is substantially the same as an RMS coil current through the one or more transmit coils at the fundamental frequency.

16. The apparatus of claim 15, wherein:
the controller is to:
determine the fundamental frequency;
determine the lower frequency relative to the fundamental frequency; and
determine the upper frequency relative to the fundamental frequency and the lower frequency, the determining of the upper frequency at least partially based on an output result of a non-linear expression of operating frequency versus RMS coil current or power of the wireless power transmitter using a determined value of an RMS coil current or power at the upper frequency as an input, the determined value at least partially based on a coil current difference between the RMS coil current or power at the lower frequency and an RMS coil current or power at the fundamental frequency.

17. The apparatus of claim 16, wherein:
the wireless power transmitter comprises:
a memory, the memory to store multiple parameters that represent, at least in part, the non-linear expression of operating frequency versus RMS coil current or power of the wireless power transmitter.

18. The apparatus of claim 16, wherein the determined value is substantially equal or proportional to a difference between the RMS coil current or power at the fundamental frequency and the coil current difference between the RMS coil current or power at the lower frequency and the RMS coil current or power at the fundamental frequency.

19. The apparatus of claim 17, wherein:
the controller is to:
determine the RMS coil current or power at the fundamental frequency at least partially based on an output result of a non-linear expression of RMS coil current or power versus operating frequency using the fundamental frequency as an input; and
determine the RMS coil current or power at the lower frequency at least partially based on an output result of the non-linear expression of RMS coil current or power versus operating frequency using the lower frequency as an input.

20. A method comprising:
at a controller of a wireless power transmitter having a multi-frequency operation:
determining a fundamental frequency of a wireless power transmission signal, the wireless power transmission signal at the fundamental frequency to produce a first root mean square (RMS) coil current or power through one or more transmit coils of the wireless power transmitter;
determining a lower frequency of the wireless power transmission signal relative to the fundamental frequency, the lower frequency offset from the fundamental frequency by a first offset, the wireless power transmission signal at the lower frequency to produce a second RMS coil current or power through the one or more transmit coils; and
determining an upper frequency of the wireless power transmission signal relative to the fundamental frequency, the upper frequency offset from the fundamental frequency by a second offset, the second offset different from the first offset, the wireless power transmission signal at the upper frequency to produce a third RMS coil current or power through the one or more transmit coils, the first offset associated with the lower frequency and the second offset associated with the upper frequency to ensure an RMS coil current or power in the multi-frequency operation is substantially the same as the first RMS coil current or power at the fundamental frequency.

21. The method of claim 20, wherein the wireless power transmitter includes inductor-capacitor (L-C) resonant circuitry to exhibit a non-linear relationship between operating frequency and transmit power.

22. The method of claim 20, wherein determining the upper frequency comprises:
determining the upper frequency relative to the fundamental frequency and the lower frequency, the determining of the upper frequency at least partially based on an output result of a non-linear expression of operating frequency versus RMS coil current or power using a determined value of the third RMS coil current or power as an input, the determined value at least partially based on a coil current difference between the second RMS coil current or power at the lower frequency and the first RMS coil current or power at the fundamental frequency.

23. The method of claim 22, comprising:
at the controller of the wireless power transmitter,
determining the determined value to be substantially equal or proportional to a difference between the first RMS coil current or power and the coil current difference between the second RMS coil current or power and the first RMS coil current or power.

24. The method of claim 23, comprising:
at the controller of the wireless power transmitter,
determining the first RMS coil current or power at least partially based on an output result of a non-linear expression of RMS coil current or power versus operating frequency using the fundamental frequency as an input; and
determining the second RMS coil current or power at least partially based on an output result of the non-linear expression of RMS coil current or power versus operating frequency using the lower frequency as an input.

25. The method of claim 22, comprising:
at the wireless power transmitter,
storing, in memory, multiple parameters that represent, at least in part, the non-linear expression of operating frequency versus RMS coil current or power of the wireless power transmitter.

26. The method of claim 22, wherein the one or more transmit coils of the wireless power transmitter is to wirelessly couple with one or more receive coils of a wireless power receiver, and wherein determining the fundamental frequency comprises:
determining the fundamental frequency at least partially based on an indication in a communication received from the wireless power receiver.

27. The method of claim 22, wherein determining the lower frequency comprises:
determining the lower frequency at least partially based on a predetermined minimum frequency spread at or relative to the fundamental frequency.

28. The method of claim 22, comprising:
at the controller of the wireless power transmitter, performing a calibration process comprising:
at respective frequency points of multiple frequency points over a frequency range, generating a wireless power transmission signal at a respective frequency point, sampling a coil current through the one or more transmit coils produced from the wireless power transmission signal at the respective frequency point, and storing in memory a respective sampled coil current value in association with the respective frequency point; and
determining the non-linear expression of operating frequency versus RMS coil current or power at least partially based on sampled coil current values stored in association with the respective frequency points.

29. The method of claim 28, wherein determining the non-linear expression of operating frequency versus RMS coil current is at least partially based on performing a least-squares method in relation to the sampled coil current values stored in association with the respective frequency points.

30. The method of claim 20, wherein determining the upper frequency comprises:
determining the upper frequency relative to the fundamental frequency and the lower frequency, the determining of the upper frequency at least partially based on a data table lookup in a prestored data table of operating frequency versus RMS coil current or power of the wireless power transmitter using a determined value of the third RMS coil current or power as an index, the determined value at least partially based on a difference between the second RMS coil current or power at the lower frequency and the first RMS coil current or power at the fundamental frequency.

31. The method of claim 30, comprising:
at the controller of the wireless power transmitter, performing a calibration process comprising:
at respective frequency points of multiple frequency points over a frequency range, generating a wireless power transmission signal at a respective frequency point, sampling a coil current through the one or more transmit coils produced from the wireless power transmission signal at the respective frequency point, and storing in memory a respective sampled coil current value in association with the respective frequency point; and
generating the prestored data table of operating frequency versus RMS coil current or power at least partially based on sampled coil current values stored in association with the respective frequency points.

32. The method of claim 20, comprising:
at the controller of the wireless power transmitter,
generating the wireless power transmission signal at the fundamental frequency, at the lower frequency, and at the upper frequency.

33. The method of claim 20, comprising:
at the controller of the wireless power transmitter,
generating the wireless power transmission signal; and
controlling an operating frequency of the wireless power transmission signal to repeatedly switch between the fundamental frequency and one of the lower frequency and the upper frequency in an alternating manner.

34. The method of claim 33, wherein controlling the operating frequency of the wireless power transmission signal comprises controlling the operating frequency of the wireless power transmission signal to repeatedly switch in the alternating manner at a rate of greater than or equal to 20 kilohertz (kHz).

35. An apparatus comprising:
a wireless power transmitter comprising:
a transmitter circuitry, the transmitter circuitry including one or more transmit coils to inductively couple with one or more receive coils of a wireless power receiver; and
a controller operably coupled to the transmitter circuitry, the controller to:
determine a fundamental frequency of a wireless power transmission signal, the wireless power transmission signal at the fundamental frequency to produce a first root mean square (RMS) coil current or power through the one or more transmit coils;
determine a lower frequency of the wireless power transmission signal relative to the fundamental frequency, the lower frequency offset from the fundamental frequency by a first offset, the wireless power transmission signal at the lower frequency to produce a second RMS coil current or power through the one or more transmit coils; and
determine an upper frequency of the wireless power transmission signal relative to the fundamental frequency, the upper frequency offset from the fundamental frequency by a second offset, the second offset different from the first offset, the wireless power transmission signal at the upper frequency to produce a third RMS coil current or power through the one or more transmit coils, the first offset associated with the lower frequency and the second offset associated with the upper frequency to ensure an RMS coil current or power in a multi-frequency operation is substantially the same as the first RMS coil current or power at the fundamental frequency.

36. The apparatus of claim 35, wherein the transmitter circuitry includes inductor-capacitor (L-C) resonant circuitry to exhibit a non-linear relationship between operating frequency and transmit power.

37. The apparatus of claim 35, wherein the controller is to:
determine the upper frequency relative to the fundamental frequency and the lower frequency, the determining of the upper frequency at least partially based on an output result of a non-linear expression of operating frequency versus RMS coil current or power using a determined value of the third RMS coil current or power as an input, the determined value at least partially based on a difference between the second RMS coil current or power at the lower frequency and the first RMS coil current or power at the fundamental frequency.
